(19) United States
(12) Patent Application Publication
(10) Pub. No.: US 2024/0056192 A1
(43) Pub. Date: Feb. 15, 2024

(54) TRANSMITTER, TRANSMISSION DEVICE, COMMUNICATION DEVICE, AND COMMUNICATION SYSTEM

(71) Applicant: NEC CORPORATION, TOKYO (JP)

(72) Inventors: KOYA TAKATA, TOKYO (JP); HISASHI MIZUMOTO, TOKYO (JP); FUJIO OKUMURA, KANAGAWA (JP)

(73) Assignee: NEC CORPORATION, TOKYO (JP)

(21) Appl. No.: 18/223,995

(22) Filed: Jul. 19, 2023

(30) Foreign Application Priority Data
Aug. 9, 2022 (JP) 2022-127020

(51) Int. Cl. H04B 10/516; H04B 10/50

(52) U.S. Cl. CPC H04B 10/516; H04B 10/501

(57) ABSTRACT

A transmitter including a light source, a spatial optical modulator including a modulation part in which a phase image according to a spatial optical signal to be transmitted is set and irradiated with light emitted from the light source, an optical diffuser that diffuses modulated light modulated by the modulation part of the spatial optical modulator, and a ball lens that enlarges and projects the modulated light diffused by the optical diffuser.

This application is based upon and claims the benefit of priority from Japanese Patent Application No. 2022-127020, filed on Aug. 9, 2022, the disclosure of which is incorporated herein in its entirety by reference.

### TECHNICAL FIELD

The present disclosure relates to a transmission device and the like that transmit an optical signal propagating in a space.

### BACKGROUND ART

In optical space communication, optical signals (hereinafter also referred to as spatial optical signals) propagating in space are transmitted and received. To transmit the spatial optical signal in a wide range, it is favorable that a projection angle of projection light is as large as possible. For example, it is possible to widen the projection angle by controlling a pattern set in a modulation part of a phase modulation-type spatial optical modulator by using a transmission device including the spatial optical modulator. It is possible to construct a communication network using the spatial optical signal by transmitting the spatial optical signal in multiple directions around the transmission device.

Patent Literature 1 (JP 2020-536372 W) discloses a light source device configured for visible light communication. The device of Patent Literature 1 includes a light emitting element, a path, a wavelength conversion element, a beam shaping mechanism, and a beam steering mechanism. The light emitting element outputs directional electromagnetic radiation having a first peak wavelength modulated using a modulation signal supplied by a driver. The wavelength conversion element is optically coupled to the path that directs the directional electromagnetic radiation and receives the directional electromagnetic radiation from the light receiving element. The wavelength conversion element converts directional electromagnetic radiation having the first peak wavelength into a second peak wavelength longer than the first peak wavelength. The wavelength conversion element outputs a white spectrum including the second peak wavelength and partially the first peak wavelength. The beam shaping mechanism changes an angular distribution of the white spectrum. For example, a collimate lens, an aspherical lens, a ball lens, or the like is used as the beam shaping mechanism. The beam steering mechanism scans the white spectrum within a spatial range around a target object and directs the directional electromagnetic radiation having the first peak wavelength to the target object.

Patent Literature 2 (JP 2016-176996 A) discloses an image projection device using light obtained by modulating laser light. The device of Patent Literature 2 includes a light source, an optical modulator, a Fourier transform lens, a screen, and a projection optical system. The light source emits laser light. The optical modulator modulates the laser light incident from the light source on the basis of hologram data and emits the modulated laser light. The Fourier transform lens performs Fourier transform for the light emitted from the optical modulator. The zero-order light emitted from the optical modulator is condensed at a rear focal position of the Fourier transform lens. An image forming position of an image by first-order diffracted light is set at a position on the rear side of the rear focal position of the Fourier transform lens on an optical axis of the Fourier transform lens by modulation based on the hologram data. The screen is disposed at the image forming position of the image by the first-order diffracted light. The projection optical system is a concave mirror. The projection optical system projects a projection image by reflecting the image formed on the screen, by a concave reflection surface.

The device of Patent Literature 1 scans the target object using the white spectrum including the first peak wavelength and the second peak wavelength, and then directs the directional electromagnetic radiation having the first peak wavelength to the target object. The device of Patent Literature 1 changes the angular distribution of the white spectrum using the beam shaping mechanism. The device of Patent Literature 1 can be used for displaying an image in a narrow space such as indoors. However, it has been difficult to apply the device of Patent Literature 1 to an application of transmitting a spatial optical signal having directivity toward a communication target in a wide space such as outdoors.

The device of Patent Literature 2 reflects the image formed on the screen, by the concave reflection surface to enlarge and project the image. The image projected from the device of Patent Literature 2 is enlarged and projected by the concave reflection surface. Therefore, it has been difficult to apply the device of Patent Literature 2 to an application of transmitting the spatial optical signal having directivity toward the communication target.

In a case where the position of the communication target is fixed, the optical axis of the spatial optical signal is uniquely determined. In such a case, a spatial optical signal having a large beam diameter can be transmitted toward the communication target. However, the optical axis of the spatial optical signal is not uniquely determined in communication with a plurality of communication devices or mobile bodies. In such a case, the spatial optical signal is emitted toward the plurality of communication targets, and thus the beam diameter of the spatial optical signal becomes narrow near the transmission device. The spatial optical signal having a narrow beam diameter is likely to attenuate before reaching a distant communication target due to an influence of disturbance such as rain.

An object of the present disclosure is to provide a transmitter and the like capable of transmitting a spatial optical signal having directivity that is less likely to be affected by disturbance such as rain.

### SUMMARY

A transmitter according to an aspect of the present disclosure includes a light source, a spatial optical modulator including a modulation part in which a phase image according to a spatial optical signal to be transmitted is set and irradiated with light emitted from the light source, an optical diffuser that diffuses modulated light modulated by the modulation part of the spatial optical modulator, and a ball lens that enlarges and projects the modulated light diffused by the optical diffuser.

### BRIEF DESCRIPTION OF THE DRAWINGS

Exemplary features and advantages of the present invention will become apparent from the following detailed description when taken with the accompanying drawings in which:

FIG. 1 is a conceptual diagram illustrating an example of a configuration of a transmission device according to a first example embodiment;

FIG. 2 is a conceptual diagram illustrating an example of the configuration of the transmission device according to the first example embodiment;

FIG. 3 is a conceptual diagram illustrating an example of a configuration of a transmission device according to a modification 1-1 of the first example embodiment;

FIG. 4 is a conceptual diagram illustrating an example of a configuration of a transmission device according to a modification 1-2 of the first example embodiment;

FIG. 5 is a conceptual diagram illustrating an example of a configuration of a transmission device according to a modification 1-3 of the first example embodiment;

FIG. 6 is a conceptual diagram illustrating an example of the configuration of the transmission device according to the modification 1-3 of the first example embodiment;

FIG. 7 is a conceptual diagram illustrating an example of a configuration of a transmission device according to a second example embodiment;

FIG. 8 is a conceptual diagram illustrating an example of a configuration of a transmission device according to a modification 2-1 of the second example embodiment;

FIG. 9 is a conceptual diagram illustrating an example of a configuration of a transmission device according to a third example embodiment;

FIG. 10 is a conceptual diagram illustrating an example of a configuration of a transmission device according to a modification 3-1 of the third example embodiment;

FIG. 11 is a conceptual diagram illustrating an example of a configuration of a transmission device according to a fourth example embodiment;

FIG. 12 is a conceptual diagram illustrating an example of a configuration of a communication device according to a fifth example embodiment;

FIG. 13 is a conceptual diagram illustrating an example of a configuration of a reception device included in the communication device according to the fifth example embodiment;

FIG. 14 is a conceptual diagram illustrating an example of the configuration of the communication device according to the fifth example embodiment;

FIG. 15 is a conceptual diagram illustrating an example of the configuration of the communication device according to an application example 1 of the fifth example embodiment;

FIG. 16 is a conceptual diagram illustrating an example of a configuration of a transmitter according to a sixth example embodiment; and

FIG. 17 is a block diagram illustrating an example of a hardware configuration that executes control and processing in each example embodiment.

### EXAMPLE EMBODIMENT

Example embodiments of the present invention will be described below with reference to the drawings. In the following example embodiments, technically preferable limitations are imposed to carry out the present invention, but the scope of this invention is not limited to the following description. In all drawings used to describe the following example embodiments, the same reference numerals denote similar parts unless otherwise specified. In addition, in the following example embodiments, a repetitive description of similar configurations or arrangements and operations may be omitted.

In all the drawings used for description of the following example embodiments, the directions of the arrows in the drawings are merely examples, and do not limit the directions of light and signals. Further, a line indicating a trajectory of light in the drawings is conceptual and does not accurately represent actual traveling direction or state of light. For example, in the drawings, a change in a traveling direction or a state of light due to refraction, reflection, diffusion, or the like at an interface between air and a substance may be omitted, or a light flux may be expressed by a single line. Further, there is a case where hatching is not applied to the cross section for reasons that an example of a light path is illustrated or the configuration is complicated.

### First Example Embodiment

First, a transmission device according to a first present example embodiment will be described with reference to the drawings. The transmission device of the present example embodiment is used for optical space communication in which optical signals (hereinafter, also referred to as spatial optical signals) propagating in a space are transmitted and received without using a medium such as an optical fiber. The transmission device of the present example embodiment may be used for applications other than optical space communication as long as the applications are for transmitting light propagating in a space. The drawings used in the description of the present example embodiment are conceptual and do not accurately depict an actual structure.

(Configuration)

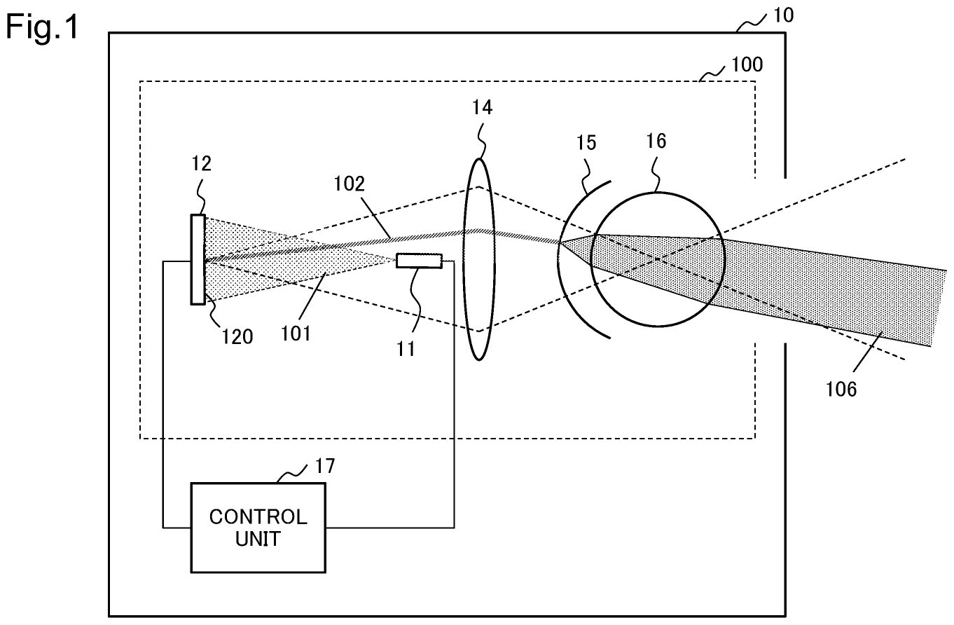

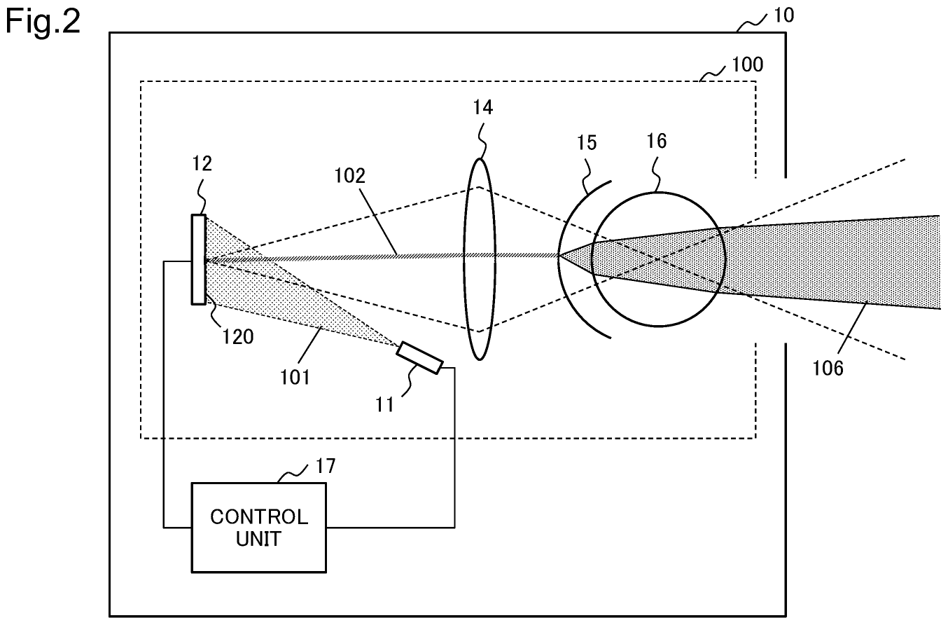

FIGS. 1 and 2 are conceptual diagrams illustrating examples of configurations of a transmission device 10 according to the present example embodiment. The transmission device 10 includes a light source 11, a spatial optical modulator 12, a condenser lens 14, a diffuser 15, a ball lens 16, and a control unit 17. The light source 11, the spatial optical modulator 12, the condenser lens 14, the diffuser 15, and the ball lens 16 constitute a transmitter 100. The condenser lens 14 and the diffuser 15 constitute an optical diffuser. FIG. 1 is a plan view of an internal configuration of the transmitter 100 as viewed from above. FIG. 2 is a side view of the internal configuration of the transmitter 100 as viewed from a side. FIGS. 1 and 2 illustrate a cross section of the diffuser 15. FIGS. 1 and 2 are conceptual and do not accurately represent a shape of each configuration element, a positional relationship between configuration elements, travel of light, and the like.

The light source 11 emits light 101 under the control of the control unit 17. For example, the light source 11 includes a collimate lens. The light 101 becomes substantially parallel light through the collimate lens. The substantially parallel light may include light beams that are not parallel light beams. That is, the substantially parallel light may include not only parallel light beams but also diverging light beams and converging light beams. An optical axis of the light source 11 is obliquely set with respect to a surface of a modulation part 120 of the spatial optical modulator 12. The light source 11 emits laser light in a predetermined wavelength band under the control of the control unit 17. The wavelength of the laser light emitted from the light source 11 is not particularly limited, and may be selected according to application. For example, the light source 11 emits laser light in a visible or infrared wavelength band. For example, near-infrared rays of 800 to 1000 nanometers (nm) can have an increased laser class as compared with visible light, so that sensitivity can be improved as compared with visible light. For example, in the case of infrared rays in a wavelength band of 1.55 micrometers (μm), a higher-output laser light source than near-infrared rays of 800 to 1000 nm can be used. As a laser light source that emits infrared rays in a wavelength band of 1.55 μm, an aluminum gallium arsenide phosphorus (AlGaAsP)-based laser light source, an indium gallium arsenide (InGaAs)-based laser light source, or the like can be used. The longer the wavelength of the laser light is, the larger the diffraction angle can be made and the higher the energy can be set.

The spatial optical modulator 12 is disposed in an optical path of the light 101 emitted from the light source 11. The spatial optical modulator 12 includes the modulation part 120. A modulation region is set in the modulation part 120. In the modulation region of the modulation part 120, a pattern (also referred to as a phase image) according to an image displayed with projection light 106 is set under the control of control unit 17. The modulation part 120 is irradiated with the light 101 emitted from the light source 11. The light 101 incident on the modulation part 120 is modulated according to the pattern (phase image) set in the modulation part 120. Modulated light 102 modulated by the modulation part 120 travels toward an incident surface of condenser lens 14.

For example, the spatial optical modulator 12 is implemented by a spatial optical modulator using ferroelectric liquid crystal, homogeneous liquid crystal, vertical alignment liquid crystal, or the like. For example, the spatial optical modulator 12 can be implemented by a liquid crystal on silicon (LCOS). Further, the spatial optical modulator 12 may be implemented by a micro electro-mechanical system (MEMS). The phase modulation-type spatial optical modulator 12 can concentrate energy on an image portion by sequentially switching a portion on which the projection light 106 is projected. Therefore, in the case of using the phase modulation-type spatial optical modulator 12, it is possible to display an image brighter than other schemes when the output of the light source 11 is the same.

The modulation region of the modulation part 120 is divided into a plurality of regions (also referred to as tiling). For example, the modulation region of the modulation part 120 is divided into rectangular regions (also referred to as tiles) having a desired aspect ratio. A phase image is allocated to the plurality of tiles set in the modulation region of the modulation part 120. Each of the plurality of tiles includes a plurality of pixels. A phase image associated to an image to be projected is set in each of the plurality of tiles. The phase images set to the plurality of tiles may be the same or different.

A phase image is tiled to each of the plurality of tiles allocated to the modulation region of the modulation part 120. For example, a phase image generated in advance is set in each of the plurality of tiles. When the modulation part 120 is irradiated with the light 101 in the state where the phase images are set in the plurality of tiles, the modulated light 102 that forms an image associated to the phase image of each tile is emitted. As the number of tiles set in the modulation part 120 increases, a clearer image can be displayed. However, as the number of pixels of each tile decreases, a resolution decreases. Therefore, the size and number of tiles set in the modulation region of the modulation part 120 are set according to the application.

The condenser lens 14 is disposed between the spatial optical modulator 12 and the diffuser 15. The incident surface of the condenser lens 14 is set to face the spatial optical modulator 12. The modulated light 102 modulated by the modulation part 120 of the spatial optical modulator 12 is incident on the incident surface of the condenser lens 14. An emission surface of the condenser lens 14 is set to face the diffuser 15. The modulated light 102 incident in the condenser lens 14 is refracted according to a refractive index of the condenser lens 14 and is emitted from the emission surface. The modulated light 102 emitted from the condenser lens 14 is condensed toward the diffuser 15.

For example, the condenser lens 14 can be configured by a material such as glass, crystal, or resin. In a case of receiving a spatial optical signal in a visible region, the condenser lens 14 can be implemented by a material that transmits/refracts light in the visible region. For example, optical glass such as crown glass or flint glass can be applied to the condenser lens 14. For example, crown glass such as Boron Kron (BK) can be applied to the condenser lens 14. For example, flint glass such as Lanthanum Schwerflint (LaSF) can be applied to the condenser lens 14. For example, quartz glass can be applied to the condenser lens 14. For example, a crystal such as sapphire can be applied to the condenser lens 14. For example, a transparent resin such as acryl can be applied to the condenser lens 14.

In a case where the spatial optical signal is light in a near-infrared region (hereinafter also referred to as near-infrared rays), a material that transmits the near-infrared rays is used for the condenser lens 14. For example, in a case of receiving a spatial optical signal in a near-infrared region of about 1.5 micrometers (μm), a material such as silicon can be applied to the condenser lens 14 in addition to glass, crystal, resin, or the like. In a case where the spatial optical signal is light in an infrared region (hereinafter also referred to as infrared rays), a material that transmits the infrared rays is used for the condenser lens 14. For example, in a case where the spatial optical signal is infrared rays, a silicon, germanium, or chalcogenide-based material can be applied to the condenser lens 14. The material of the condenser lens 14 is not limited as long as the material can transmit/refract light in the wavelength region of the spatial optical signal. The material of the condenser lens 14 may be appropriately selected according to the required refractive index and use.

The diffuser 15 is a transmissive diffuser (also referred to as a transparent diffuser) having a spherical dome shape. Randomly arrayed minute concave lenses are formed in an array on the incident surface (convex surface) of the diffuser 15. The modulated light 102 condensed by the condenser lens 14 is incident in the diffuser 15. The diffuser 15 diffuses the incident modulated light 102 by micro-lenses formed in an array. The modulated light 102 diffused by the diffuser 15 travels toward the ball lens 16. The modulated light 102 is diffused at the position where the micro-lens is formed. Therefore, the range of the modulated light 102 to be incident in the ball lens 16 can be shaped according to the range in which the micro-lens is formed.

The diffuser 15 is favorably made of a material through which the spatial optical signal is easily transmitted. For example, the diffuser 15 can be formed using a transparent substrate made of polycarbonate, polyester, acrylic, or glass. A diffusion angle of the diffuser 15 can be adjusted by a state of the micro-lens. The diffusion angle of the modulated light 102 after passing through the diffuser 15 corresponds to a square root value of a sum of a square of a divergence angle of the incident light and a square of the diffusion angle of the diffuser 15. The smaller the size and the larger the density of the micro-lens, the larger the diffusion angle of the diffuser 15. The diffusion angle of the modulated light 102 after passing through the diffuser 15 may be adjusted according to a diameter of the ball lens 16, a distance between the diffuser 15 and the ball lens 16, or the like.

The ball lens 16 is a spherical lens. The ball lens 16 has a spherical shape when viewed from an optional angle. The modulated light 102 diffused by the diffuser 15 is incident in the ball lens 16. The ball lens 16 converts the incident modulated light 102 into the projection light 106 of substantially parallel light and emits the projection light. The projection light 106 emitted from the ball lens 16 travels toward a communication target (not illustrated). The projection light 106 includes diverging rays or converging rays according to progress. When the projection light 106 is transmitted from the transmission device 10, the beam diameter is enlarged by the ball lens 16. Therefore, even in a case where raindrops or the like are interposed between the transmission device 10 and the communication target due to an influence of weather, the projection light 106 is less easily attenuated.

For example, the ball lens 16 can be configured by a material such as glass, crystal, or resin. In the case of receiving the spatial optical signal in the visible region, the ball lens 16 can be implemented by the material that transmits/refracts light in the visible region. For example, optical glass such as crown glass or flint glass can be applied to the ball lens 16. For example, crown glass such as BK can be applied to the ball lens 16. For example, flint glass such as LaSF can be applied to the ball lens 16. For example, quartz glass can be applied to the ball lens 16. For example, a crystal such as sapphire can be applied to the ball lens 16. For example, a transparent resin such as acryl can be applied to the ball lens 16.

In the case where the spatial optical signal is near-infrared rays, the material that transmits the near-infrared rays is used for the ball lens 16. For example, in the case of receiving the spatial optical signal in the near-infrared region of about 1.5 nm, the material such as silicon can be applied to the ball lens 16 in addition to glass, crystal, resin, or the like. In the case where the spatial optical signal is infrared rays, the material that transmits the infrared rays is used for the ball lens 16. For example, in the case where the spatial optical signal is infrared rays, the silicon, germanium, or chalcogenide-based material can be applied to the ball lens 16. The material of the ball lens 16 is not limited as long as the material can transmit/refract light in the wavelength region of the spatial optical signal. The material of the ball lens 16 may be appropriately selected according to the required refractive index and use.

The control unit 17 (controller) controls the light source 11 and the spatial optical modulator 12. For example, the control unit 17 is implemented by a microcomputer including a processor and a memory. The control unit 17 sets a phase image associated to an image to be projected in the modulation part 120 in accordance with an aspect ratio of tiling set in the modulation part 120 of the spatial optical modulator 12. The control unit 17 sets, in the modulation part 120 of the spatial optical modulator 12, the phase image associated to the image to be projected. For example, the control unit 17 sets, in the modulation part 120, the phase image associated to an image according to use such as image display, communication, or distance measurement. The phase image of the image to be projected may be stored in advance in a storage unit (not illustrated). The shape and size of the image to be projected are not particularly limited.

The control unit 17 controls the spatial optical modulator 12 in such a way that a parameter that determines a difference between a phase of the light 101 emitted to the modulation part 120 and a phase of the modulated light 102 reflected by the modulation part 120 changes. For example, the parameter is a value related to an optical characteristic such as a refractive index or an optical path length. For example, the control unit 17 adjusts the refractive index of the modulation part 120 by changing a voltage applied to the modulation part 120 of the spatial optical modulator 12. A phase distribution of the light 101 emitted to the modulation part 120 of the phase modulation-type spatial optical modulator 12 is modulated according to the optical characteristics of the modulation part 120. Note that a method of driving the spatial optical modulator 12 by the control unit 17 is determined according to a modulation scheme of the spatial optical modulator 12.

The control unit 17 drives the light source 11 in a state where the phase image associated to the image to be displayed is set in the modulation part 120. As a result, the light 101 emitted from the light source 11 is emitted to the modulation part 120 of the spatial optical modulator 12 in accordance with timing at which the phase image is set in the modulation part 120 of the spatial optical modulator 12. The light 101 emitted to the modulation part 120 of the spatial optical modulator 12 is modulated by the modulation part 120 of the spatial optical modulator 12. The modulated light 102 modulated by the modulation part 120 of the spatial optical modulator 12 is emitted toward the incident surface of the condenser lens 14.

Further, the control unit 17 modulates the light 101 emitted from the light source 11 for communication with the communication target (not illustrated). In communication, the control unit 17 modulates the light 101 by controlling the timing at which the light 101 is emitted from the light source 11 in a state where the phase image for communication is set in the modulation part 120 of the spatial optical modulator 12. A modulation pattern of the light 101 in communication is optionally set. For example, a configuration for communication (communication unit) may be added separately from the control unit 17. In that case, the control unit 17 may be configured to control the light source 11 and the spatial optical modulator 12 according to a condition set by the communication unit.

(Modification)

Next, a modification of the present example embodiment will be described. Hereinafter, three modifications according to the present example embodiment will be described. The following modifications are merely examples, and do not limit modifications of the present example embodiment.

[Modification 1-1]

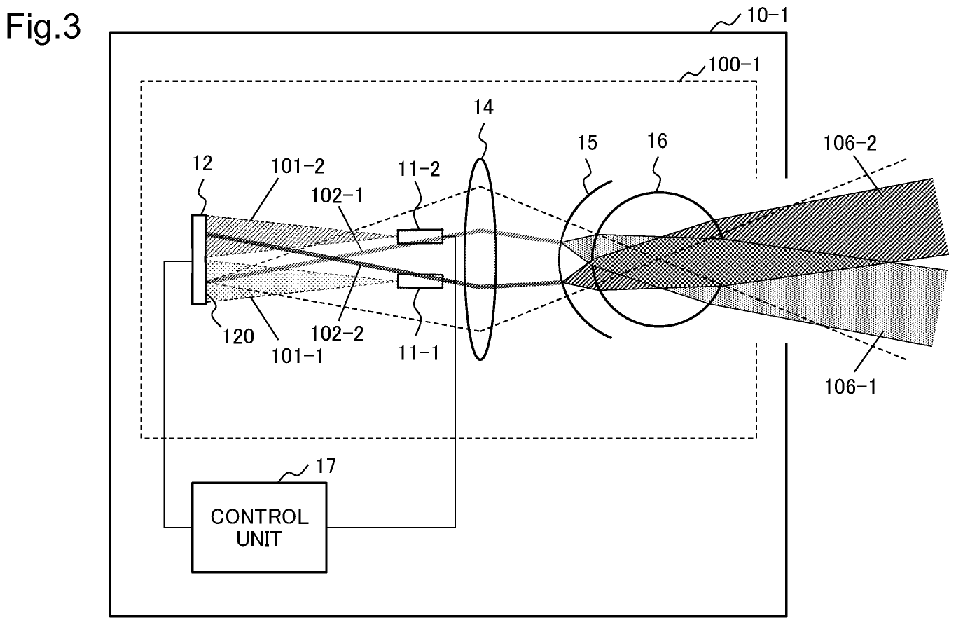

A modification 1-1 is an example in which spatial optical signals are transmitted in a plurality of directions. FIG. 3 is a conceptual diagram illustrating an example of a configuration of a transmission device 10-1 according to the modification 1-1. The transmission device 10-1 includes a light source 11-1, a light source 11-2, the spatial optical modulator 12, the condenser lens 14, the diffuser 15, the ball lens 16, and the control unit 17. The light source 11-1, the light source 11-2, the spatial optical modulator 12, the condenser lens 14, the diffuser 15, and the ball lens 16 constitute a transmitter 100-1. The condenser lens 14 and the diffuser 15 constitute an optical diffuser. FIG. 3 is a plan view of an internal configuration of the transmitter 100-1 as viewed from above. FIG. 3 illustrates a cross section of the diffuser 15. FIG. 3 is conceptual and does not accurately represent a shape of each configuration element, a positional relationship between configuration elements, travel of light, and the like. The light source 11-1 and the light source 11-2 have a similar configuration to the configuration (light source 11) in FIGS. 1 and 2. The spatial optical modulator 12, the condenser lens 14, the diffuser 15, the ball lens 16, and the control unit 17 have similar configurations to those in FIGS. 1 and 2.

The light source 11-1 emits light 101-1 under the control of the control unit 17. For example, the light source 11-1 includes a collimate lens. The light 101-1 becomes substantially parallel light through the collimate lens. As in the example of FIG. 2, an optical axis of the light source 11-1 is obliquely set with respect to the surface of the modulation part 120 of the spatial optical modulator 12. The light 101-1 emitted from the light source 11-1 is emitted to a first modulation region set in the modulation part 120 of the spatial optical modulator 12. A first phase image is set in the first modulation region under the control of the control unit 17. The light 101-1 is modulated according to the first phase image set in the first modulation region. Modulated light 102-1 modulated in the first modulation region is condensed by the condenser lens 14 and is incident on the convex surface of the diffuser 15. The modulated light 102-1 incident on the diffuser 15 is diffused by the diffuser 15 and is incident in the ball lens 16. The modulated light 102-1 incident in the ball lens 16 is converted into projection light 106-1 of substantially parallel light by the ball lens 16 and transmitted as a spatial optical signal.

The light source 11-2 emits the light 101-2 under the control of the control unit 17. For example, the light source 11-2 includes a collimate lens. The light 101-2 becomes substantially parallel light through the collimate lens. The light source 11-2 may be configured to emit light of the same wavelength as the light source 11-1, or may be configured to emit light of a different wavelength from the light source 11-1. As in the example of FIG. 2, the optical axis of the light source 11-2 is obliquely set with respect to the surface of the modulation part 120 of the spatial optical modulator 12. The light 101-2 emitted from the light source 11-2 is emitted to a second modulation region set in the modulation part of the spatial optical modulator 12. The first modulation region and the second modulation region are different regions. For example, a region where light is not reflected is set between the first modulation region and the second modulation region. A second phase image is set in the second modulation region under the control of the control unit 17. The second phase image may be the same as the first phase image or different from the first phase image. The light 101-2 is modulated according to the second phase image set in the first modulation region. Modulated light 102-2 modulated in the second modulation region is condensed by the condenser lens 14 and is incident in the diffuser 15. The modulated light 102-2 incident in the diffuser 15 is diffused by the diffuser 15 and is incident in the ball lens 16. The modulated light 102-2 incident in the ball lens 16 is converted into projection light 106-2 of substantially parallel light by the ball lens 16 and transmitted as a spatial optical signal. The projection light 106-2 is transmitted in a direction different from the projection light 106-1. Further, the projection light 106-2 may be transmitted in the same direction as the projection light 106-1.

In the present modification, a plurality of spatial optical signals derived from a plurality of light sources is transmitted in different directions. Therefore, according to the present modification, it is possible to communicate with a plurality of communication targets in the projection range of the spatial optical signals. Further, according to the present modification, the wavelengths of the spatial optical signals can be multiplexed by transmitting the spatial optical signals having different wavelengths in the same direction.

[Modification 1-2]

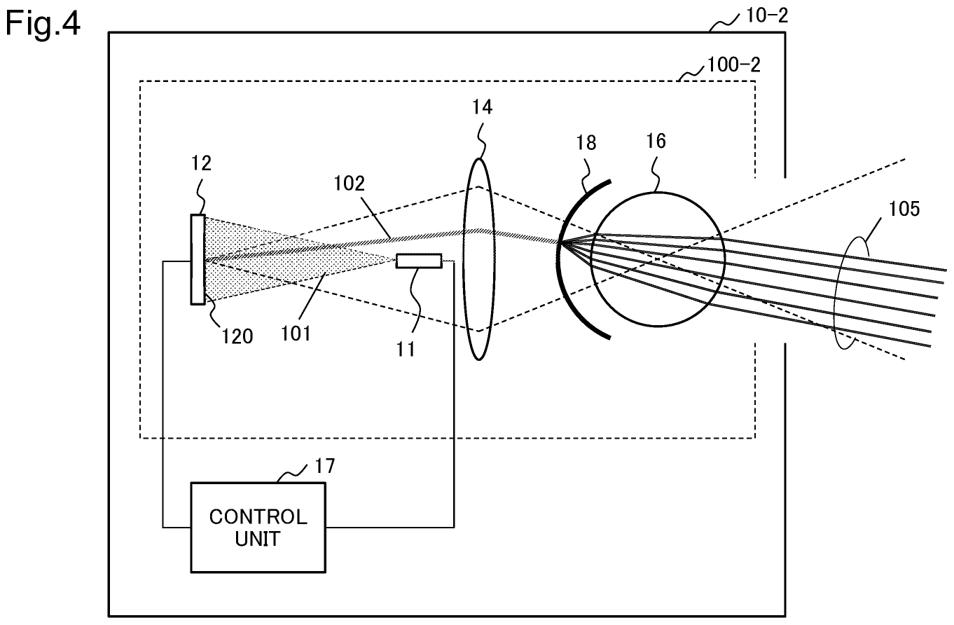

A modification 1-2 is an example in which a diffractive optical element 18 is disposed instead of the diffuser 15. FIG. 4 is a conceptual diagram illustrating an example of a configuration of a transmission device 10-2 according to the modification 1-2. The transmission device 10-2 includes the light source 11, the spatial optical modulator 12, the condenser lens 14, the diffractive optical element 18, the ball lens 16, and the control unit 17. The light source 11, the spatial optical modulator 12, the condenser lens 14, the diffractive optical element 18, and the ball lens 16 constitute a transmitter 100-2. The condenser lens 14 and the diffractive optical element 18 constitute an optical diffuser. FIG. 4 is a plan view of an internal configuration of the transmitter 100-2 as viewed from above. FIG. 4 illustrates a cross section of the diffractive optical element 18. FIG. 4 is conceptual and does not accurately represent a shape of each configuration element, a positional relationship between configuration elements, travel of light, and the like. The light source 11, the spatial optical modulator 12, the condenser lens 14, the ball lens 16, and the control unit 17 have similar configurations to those in FIGS. 1 and 2.

The diffractive optical element 18 is a transmissive diffractive optical element (DOE) having a spherical dome shape. Submicron-order irregularities are formed in a surface of the diffractive optical element 18. The irregularities in the surface of the diffractive optical element 18 can be formed by three-dimensional nanoimprinting using a dedicated mold. A convex surface of the diffractive optical element 18 is set to face the emission surface of the condenser lens 14. A concave surface of the diffractive optical element 18 is set to face the ball lens 16.

The modulated light 102 condensed by the condenser lens 14 is incident on the convex surface of the diffractive optical element 18. The diffractive optical element 18 branches the incident modulated light 102 into a plurality of light fluxes. The modulated light 102 branched into the plurality of light fluxes is emitted from the concave surface of the diffractive optical element 18 toward the ball lens 16.

The light source 11 emits light 101 under the control of the control unit 17. As in the example of FIG. 2, the optical axis of the light source 11 is obliquely set with respect to the surface of the modulation part 120 of the spatial optical modulator 12. The light 101 emitted from the light source 11 is emitted to the modulation part 120 of the spatial optical modulator 12. A phase image is set in the modulation part 120 under the control of the control unit 17. The light 101 is modulated according to the phase image set in the modulation part 120. The modulated light 102 modulated by the modulation part 120 is condensed by the condenser lens 14 and is incident on the convex surface of the diffractive optical element 18. The modulated light 102 incident on the diffractive optical element 18 is branched into the plurality of light fluxes by the diffractive optical element 18 and emitted from the concave surface of the diffractive optical element 18. The plurality of light fluxes emitted from the diffractive optical element 18 is incident in the ball lens 16. The plurality of light fluxes incident in the ball lens 16 is converted into projection light 105 of substantially parallel light by the ball lens 16 and transmitted as spatial optical signals including the plurality of light fluxes.

In the present modification, the spatial optical signals including a plurality of light fluxes are transmitted in the same direction. Compared to a single light flux, each of the plurality of light fluxes has large energy. Further, a gap is formed between the plurality of light fluxes. Therefore, according to the present modification, it is possible to transmit highly robust spatial optical signals that are less easily attenuated by an influence of weather such as rain. For example, even if one of the plurality of light fluxes is temporarily blocked, communication with a communication target can be continued as long as the remaining light fluxes arrive at the communication target.

[Modification 1-3]

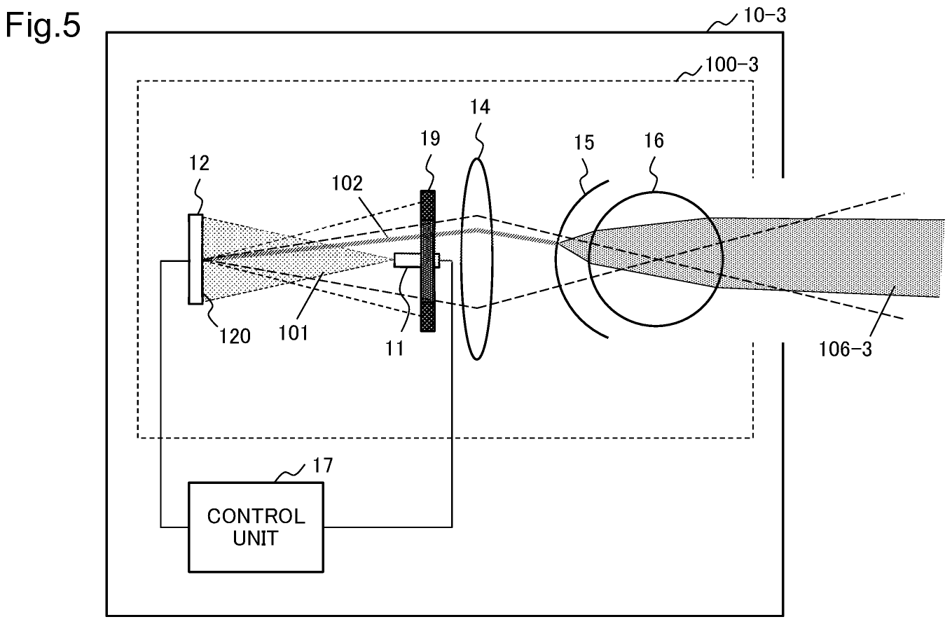

A modification 1-3 is an example in which a light shield 19 is disposed between the spatial optical modulator 12 and the condenser lens 14. FIG. 5 is a conceptual diagram illustrating an example of a configuration of a transmission device 10-3 according to the modification 1-3. The transmission device 10-3 includes the light source 11, the spatial optical modulator 12, the light shield 19, the condenser lens 14, the diffuser 15, the ball lens 16, and the control unit 17. The light source 11, the spatial optical modulator 12, the light shield 19, the condenser lens 14, the diffuser 15, and the ball lens 16 constitute a transmitter 100-3. The condenser lens 14 and the diffuser 15 constitute an optical diffuser. FIG. 5 is a plan view of an internal configuration of the transmitter 100-3 as viewed from above. FIG. 5 is conceptual and does not accurately represent a shape of each configuration element, a positional relationship between configuration elements, travel of light, and the like. The light source 11, the spatial optical modulator 12, the condenser lens 14, the ball lens 16, and the control unit 17 have similar configurations to those in FIGS. 1 and 2.

The light shield 19 is disposed between the spatial optical modulator 12 and the condenser lens 14. An opening through which the modulated light 102 projected as the projection light 106 passes is formed in the light shield 19. The light shield 19 shields zero-order light included in the modulated light 102. Further, the light shield 19 shields a high-order image included in the modulated light 102. That is, the light shield 19 shields light components (also referred to as unnecessary light) forming the zero-order light and the high-order image included in the modulated light.

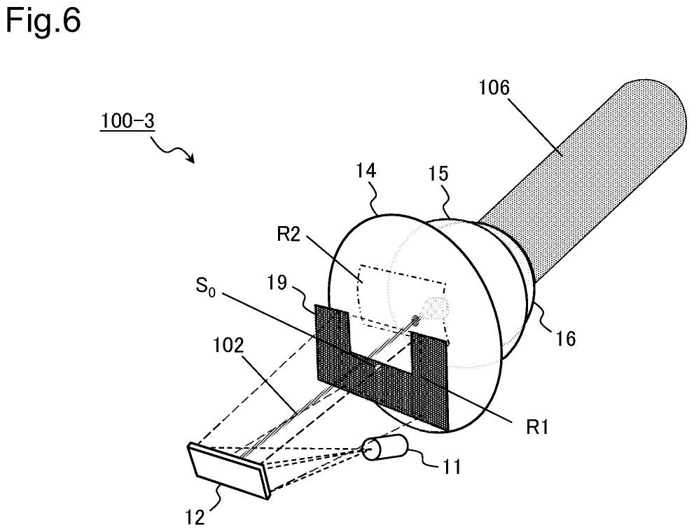

FIG. 6 is a conceptual diagram illustrating an example of a configuration of the transmitter 100-3. FIG. 6 is a view of the transmitter 100-3 as viewed from a back side of the spatial optical modulator. An irradiation range of the modulated light 102 in the light shield 19 is within a range of a region R1 indicated by the broken line. The zero-order light included in the modulated light 102 is emitted to a position of spot S0 of the light shield 19. Further, the opening of the light shield 19 is formed in accordance with a zero-order image to be projected. Therefore, a high-order image included in the modulated light 102 is emitted to the position of the light shield 19. Therefore, the modulated light 102 that has passed through the opening of the light shield 19 does not include the unnecessary light that forms the zero-order light and the high-order image. The irradiation range of the modulated light 102 in the condenser lens 14 is within the range of a region R2 indicated by the alternate long and short dash line.

The light source 11 emits the light 101 under the control of the control unit 17. The optical axis of the light source 11 is obliquely set with respect to the surface of the modulation part 120 of the spatial optical modulator 12. The light 101 emitted from the light source 11 is emitted to the modulation part 120 of the spatial optical modulator 12. A phase image is set in the modulation part 120 under the control of the control unit 17. The light 101 is modulated according to the phase image set in the modulation part 120. The modulated light 102 that has passed through the opening of the light shield 19, of the modulated light 102 modulated by the modulation part 120, is condensed by the condenser lens 14 and is incident on the convex surface of the diffuser 15. The modulated light 102-1 incident in the diffuser 15 is diffused by the diffuser 15 and is incident in the ball lens 16. The modulated light 102-1 incident in the ball lens 16 is converted into projection light 106-3 of substantially parallel light by the ball lens 16 and transmitted as a spatial optical signal.

In the present modification, the unnecessary light such as the zero-order light and the high-order image is removed by the light shield 19. Therefore, according to the present modification, it is possible to transmit a high-quality spatial optical signal by removing noise component that can be included in the spatial optical signal.

As described above, the transmission device of the present example embodiment includes the light source, the spatial optical modulator, the condenser lens, the transparent diffuser, the ball lens, and the control unit (controller). The light source, the spatial optical modulator, the condenser lens, the transparent diffuser, and the ball lens constitute a transmitter. The condenser lens and the transparent diffuser constitute an optical diffuser. The light source includes an emitter that emits laser light. The light source emits light derived from the laser light emitted from the emitter. The spatial optical modulator includes the modulation part in which the phase image according to the spatial optical signal to be transmitted is set. The modulation part is irradiated with the light emitted from the light source. The condenser lens condenses the modulated light modulated by the modulation part of the spatial optical modulator. The transparent diffuser is disposed between the condenser lens and the ball lens. The transparent diffuser diffuses the modulated light condensed by the condenser lens. The ball lens enlarges and projects the modulated light diffused by the transparent diffuser. The modulated light enlarged and projected from the ball lens is projection light (spatial optical signal) of substantially parallel light. The control unit sets the phase image to be used for spatial optical communication in the modulation part of the spatial optical modulator included in the transmitter. The control unit controls the light source included in the transmitter in such a way that the light is emitted to the modulation part to which the phase image is set.

In the present example embodiment, the light emitted from the light source is emitted to the modulation part of the spatial optical modulator. The modulated light modulated by the modulation part is once condensed by the condenser lens, then diffused by the transparent diffuser, and incident in the ball lens in a state where the beam diameter is expanded. The modulated light incident in the ball lens is projected as projection light (spatial optical signal) of substantially parallel light. Therefore, the spatial optical signal transmitted from the transmitter of the present example embodiment has a larger beam diameter immediately after transmission and is less likely to be affected by disturbance such as rain than a case where the spatial optical signal is transmitted without expanding the beam diameter. Further, since the spatial optical signal transmitted from the transmitter of the present example embodiment is substantially parallel light, it is difficult to spread even when the light is away from the transmission device and the directivity is high. That is, according to the transmitter of the present example embodiment, it is possible to transmit the directional spatial optical signal that is less likely to be affected by disturbance such as rain.

The transmission device according to an aspect of the present example embodiment includes a plurality of light sources. A modulation region in which a phase image for each light source is set is allocated to the modulation part of the spatial optical modulator. For example, a dead zone in which light emitted from a plurality of light sources is not modulated is set between adjacent modulation regions. The light emitted from the plurality of light sources is individually modulated/diffused and transmitted as different spatial optical signals. According to the present aspect, the spatial optical signals derived from the light emitted from the plurality of light sources can be transmitted to different communication targets. According to the present aspect, the spatial optical signals derived from the light emitted from the plurality of light sources can be spatially multiplexed and transmitted toward the same communication target. According to the present aspect, the spatial optical signals derived from the light of different wavelength bands emitted from the plurality of light sources can be transmitted. By transmitting the spatial optical signals derived from the light of different wavelength bands emitted from the plurality of light sources toward the same communication target, the spatial optical signals can be wavelength-multiplexed.

In an aspect of the present example embodiment, the optical diffuser includes the condenser lens and the transmissive diffractive optical element. The condenser lens condenses the modulated light modulated by the modulation part of the spatial optical modulator. The transmissive diffractive optical element is disposed between the condenser lens and the ball lens. The transmissive diffractive optical element divides the modulated light condensed by the condenser lens into a plurality of light fluxes. According to the present aspect, the spatial optical signals including a plurality of light fluxes are transmitted in the same direction. Compared to a single light flux, each of the plurality of light fluxes has large energy. Further, a gap is formed between the plurality of light fluxes. Therefore, according to the present modification, it is possible to transmit highly robust spatial optical signals that are less easily attenuated by an influence of weather such as rain.

A transmission device according to an aspect of the present example embodiment includes a light shield. The light shield is disposed between the spatial optical modulator and the condenser lens. The opening through which the modulated light transmitted as the spatial optical signal passes is formed in the light shield. The light shield shields the unnecessary light including the zero-order light and the high-order light, of the modulated light modulated by the modulation part of the spatial optical modulator. The modulated light that has passed through the light shield does not include the unnecessary light. According to the present modification, it is possible to transmit a high-quality spatial optical signal by removing noise component that can be included in the spatial optical signal.

### Second Example Embodiment

Next, a transmission device according to a second example embodiment will be described with reference to the drawings. The transmission device of the present example embodiment is different from the transmission device of the first example embodiment in that modulated light modulated by a spatial optical modulator is magnified and reflected by a reflection mirror and guided to a condenser lens.

(Configuration)

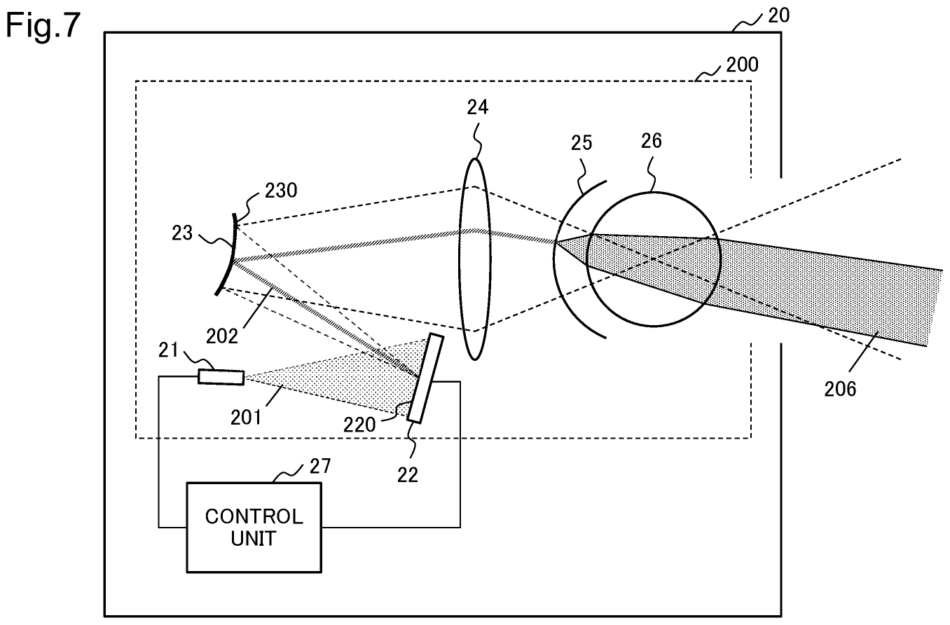

FIG. 7 is a conceptual diagram illustrating an example of a configuration of a transmission device 20 according to the present example embodiment. The transmission device 20 includes a light source 21, a spatial optical modulator 22, a reflection mirror 23, a condenser lens 24, a diffuser 25, a ball lens 26, and a control unit 27. The light source 21, the spatial optical modulator 22, the reflection mirror 23, the condenser lens 24, the diffuser 25, and the ball lens 26 constitute a transmitter 200. The condenser lens 24 and the diffuser 25 constitute an optical diffuser. FIG. 7 is a side view of an internal configuration of the transmitter 200 as viewed from a side. FIG. 7 illustrates a cross section of the diffuser 25. FIG. 7 is conceptual and does not accurately represent a shape of each configuration element, a positional relationship between configuration elements, travel of light, and the like.

The light source 21 has a similar configuration to the light source 11 of the first example embodiment. The light source 21 emits light 201 under the control of the control unit 27. An optical axis of the light source 21 is obliquely set with respect to a surface of a modulation part 220 of the spatial optical modulator 22. The light source 21 emits laser light in a predetermined wavelength band under the control of the control unit 27.

The spatial optical modulator 22 has a similar configuration to the spatial optical modulator 12 of the first example embodiment. The spatial optical modulator 22 is disposed in an optical path of the light 201 emitted from the light source 21. The spatial optical modulator 22 includes the modulation part 220. A modulation region is set in the modulation part 220. In the modulation region of the modulation part 220, a pattern (also referred to as a phase image) according to an image displayed with projection light 206 is set under the control of control unit 27. The modulation part 220 is irradiated with the light 201 emitted from the light source 21. The light 201 incident on the modulation part 220 is modulated according to a pattern (phase image) set in the modulation part 220. The modulated light 202 modulated by the modulation part 220 travels toward a reflection surface 230 of the reflection mirror 23.

The reflection mirror 23 is a reflection mirror having the curved reflection surface 230. The reflection mirror 23 enlarges a beam diameter of the modulated light 202 incident in the condenser lens 24. The reflection mirror 23 may be a flat mirror. The reflection surface 230 is set to face the modulation part 220 of the spatial optical modulator 22 and an incident surface of the condenser lens 24. For example, the reflection surface 230 has a shape of a side surface of a cylinder. For example, the reflection surface 230 may be a free-form surface or a spherical surface. For example, the reflection surface 230 may not be a single curved surface but may have a shape obtained by combining a plurality of curved surfaces. For example, the reflection surface 230 may have a shape of a combination of a curved surface and a flat surface.

The reflection mirror 23 is disposed with the reflection surface 230 facing the modulation part 220 of the spatial optical modulator 22. The reflection mirror 23 is disposed on the optical path of the modulated light 202 modulated by the modulation part 220. The reflection surface 230 is irradiated with the modulated light 202 modulated by the modulation part 220. The modulated light 202 emitted to the reflection surface 230 is reflected by the reflection surface 230. The modulated light 202 reflected by the reflection surface 230 travels toward the incident surface of the condenser lens 24 while being enlarged at an enlargement ratio according to a curvature of the reflection surface 230.

The condenser lens 24 has a similar configuration to the condenser lens 14 of the first example embodiment. The condenser lens 24 is disposed between the reflection mirror 23 and the diffuser 25. The incident surface of the condenser lens 24 is set to face the reflection surface 230 of the reflection mirror 23. The modulated light 202 reflected by the reflection surface 230 of the reflection mirror 23 is incident on the incident surface of the condenser lens 24. An emission surface of the condenser lens 24 is set to face the diffuser 25. The modulated light 202 incident in the condenser lens 24 is refracted according to a refractive index of the condenser lens 24 and is emitted from the emission surface. The modulated light 202 emitted from the condenser lens 24 is condensed toward the diffuser 25.

The diffuser 25 has a similar configuration to the diffuser 15 of the first example embodiment. The diffuser 25 is a transmissive optical diffuser (transparent diffuser) having a spherical dome shape. The modulated light 202 condensed by the condenser lens 24 is incident in the diffuser 25. The diffuser 25 diffuses the incident modulated light 202 by micro-lenses formed in an array shape. The modulated light 202 diffused by the diffuser 25 travels toward the ball lens 26. The modulated light 202 is diffused at a position where the micro-lens is formed. Therefore, a range of the modulated light 202 to be incident in the ball lens 26 can be shaped according to a range in which the micro-lens is formed.

The ball lens 26 has a similar configuration to the ball lens 16 of the first example embodiment. The ball lens 26 is a spherical lens. The beam diameter of the modulated light 202 incident in the ball lens 26 is enlarged according to the curvature of the reflection surface 230 of the reflection mirror 23. Therefore, the diameter of the ball lens 26 can be enlarged as compared with the ball lens 16 of the first example embodiment. The modulated light 202 diffused by the diffuser 25 is incident in the ball lens 26. The ball lens 26 converts the incident modulated light 202 into the projection light 206 of substantially parallel light and emits the projection light. The projection light 206 emitted from the ball lens 26 travels toward a communication target (not illustrated). When the projection light 206 is transmitted from the transmission device 20, the beam diameter is enlarged by the ball lens 26. Therefore, even in a case where raindrops or the like are interposed between the transmission device 20 and the communication target due to an influence of weather, the projection light 206 is less easily attenuated.

The control unit 27 (controller) has a similar configuration to the control unit 17 of the first example embodiment. The control unit 27 controls the light source 21 and the spatial optical modulator 22. The control unit 27 sets, in the modulation part 220 of the spatial optical modulator 22, the phase image associated to the image to be projected. The control unit 27 drives the light source 21 in a state where the phase image associated to the projection image is set in the modulation part 220. As a result, the light 201 emitted from the light source 21 is emitted to the modulation part 220 of the spatial optical modulator 22 in accordance with timing at which the phase image is set in the modulation part 220 of the spatial optical modulator 22. The light 201 emitted to the modulation part 220 of the spatial optical modulator 22 is modulated by the modulation part 220. The modulated light 202 modulated by the modulation part 220 is emitted toward the incident surface of condenser lens 24. Further, the control unit 27 modulates the light 201 emitted from the light source 21 for communication with the communication target (not illustrated). In communication, the control unit 27 modulates the light 201 by controlling the timing at which the light 201 is emitted from the light source 21 in a state where the phase image for communication is set in the modulation part 220 of the spatial optical modulator 22.

(Modification)

Next, a modification of the present example embodiment will be described. Hereinafter, a modification having a configuration in which spatial optical signals are transmitted in a plurality of directions will be described. The following modification is merely an example, and does not limit modifications of the present example embodiment.

[Modification 2-1]

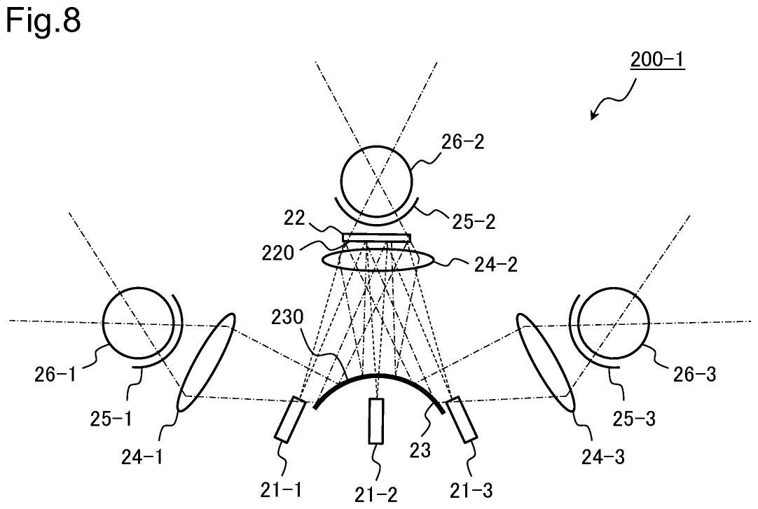

A modification 2-1 is an example in which spatial optical signals are transmitted in a plurality of directions. FIG. 8 is a conceptual diagram illustrating an example of a configuration of a transmitter 200-1 according to the modification 2-1. The transmitter 200-1 includes a plurality of light sources 21-1 to 21-3, the spatial optical modulator 22, condenser lenses 24-1 to 24-3, a plurality of diffusers 25-1 to 25-3, and a plurality of ball lenses 26-1 to 26-3. FIG. 8 illustrates an example of the transmitter 200-1 including three projection units each including the light source 21, the condenser lens 24, the diffuser 25, and the ball lens 26. The condenser lens 24 and the diffuser 25 constitute an optical diffuser. The plurality of light sources 21-1 to 3 and the spatial optical modulator 22 are controlled by a control unit (not illustrated).

FIG. 8 is a plan view of an internal configuration of the transmitter 200-1 as viewed from above. FIG. 8 illustrates a cross section of the diffuser 25. FIG. 8 is conceptual and does not accurately represent a shape of each configuration element, a positional relationship between configuration elements, travel of light, and the like. The light sources 21-1 to 21-3, the spatial optical modulator 22, the condenser lenses 24-1 to 24-3, the diffusers 25-1 to 25-3, the ball lenses 26-1 to 26-3, and the control unit have similar configurations to those in FIG. 7.

The light source 21-1 emits light under the control of the control unit. The optical axis of the light source 21-1 is obliquely set with respect to the surface of the modulation part 220 of the spatial optical modulator 22. The light emitted from the light source 21-1 is emitted to a first modulation region set in the modulation part 220 of the spatial optical modulator 22. A first phase image is set in the first modulation region under the control of the control unit. The light is modulated according to the first phase image set in the first modulation region. The modulated light modulated in the first modulation region travels toward a first reflection region of the reflection surface 230 of the reflection mirror 23. The modulated light that has reached the reflection mirror 23 is reflected by the first reflection region of the reflection surface 230 and travels toward the condenser lens 24-1. The modulated light that has reached the condenser lens 24-1 is condensed by the condenser lens 24-1, and is incident on a convex surface of the diffuser 25-1. The modulated light incident in the diffuser 25-1 is diffused by the diffuser 25-1 and is incident in the ball lens 26-1. The modulated light incident in the ball lens 26-1 is converted into substantially parallel light (projection light) by the ball lens 26-1 and transmitted as a spatial optical signal.

The light source 21-2 emits light under the control of the control unit. The optical axis of the light source 21-2 is obliquely set with respect to the surface of the modulation part 220 of the spatial optical modulator 22. The light emitted from the light source 21-2 is emitted to a second modulation region set in the modulation part 220 of the spatial optical modulator 22. A second phase image is set in the second modulation region under the control of the control unit. The light is modulated according to the second phase image set in the second modulation region. The modulated light modulated in the second modulation region travels toward a second reflection region of the reflection surface 230 of the reflection mirror 23. The modulated light that has reached the reflection mirror 23 is reflected by the second reflection region of the reflection surface 230 and travels toward the condenser lens 24-2. The modulated light that has reached the condenser lens 24-2 is condensed by the condenser lens 24-2, and is incident on the convex surface of the diffuser 25-2. The modulated light incident in the diffuser 25-2 is diffused by the diffuser 25-2 and is incident in the ball lens 26-2. The modulated light incident in the ball lens 26-2 is converted into the projection light of substantially parallel light by the ball lens 26-2 and transmitted as a spatial optical signal.

The light source 21-3 emits light under the control of the control unit. As in the example of FIG. 2, the optical axis of the light source 21-3 is obliquely set with respect to the surface of the modulation part 220 of the spatial optical modulator 22. The light emitted from the light source 21-3 is emitted to a third modulation region set in the modulation part 220 of the spatial optical modulator 22. A third phase image is set in the third modulation region under the control of the control unit. The light is modulated according to the third phase image set in the third modulation region. The modulated light modulated in the third modulation region travels toward a third reflection region of the reflection surface 230 of the reflection mirror 23. The modulated light that has reached the reflection mirror 23 is reflected by the third reflection region of the reflection surface 230 and travels toward the condenser lens 24-3. The modulated light that has reached the condenser lens 24-3 is condensed by the condenser lens 24-3, and is incident on the convex surface of the diffuser 25-3. The modulated light incident in the diffuser 25-3 is diffused by the diffuser 25-3 and is incident in the ball lens 26-3. The modulated light incident in the ball lens 26-3 is converted into the projection light of substantially parallel light by the ball lens 26-3 and transmitted as a spatial optical signal.

The light sources 21-1 to 21-3 may be configured to emit light of the same wavelength or may be configured to emit light of different wavelengths. The first modulation region, the second modulation region, and the third modulation region are different regions. For example, a region where light is not reflected is set between the first modulation region, the second modulation region, and the third modulation region. The first phase image, the second phase image, and the third phase image may be the same or different. The projection light (spatial optical signals) projected from the ball lenses 26-1 to 26-3 are transmitted in different directions. In the case of the example of FIG. 8, the spatial optical signals can be transmitted in directions of 180 degrees in the same plane.

In the present modification, a plurality of spatial optical signals derived from a plurality of light sources is transmitted in different directions. Therefore, according to the present modification, it is possible to communicate with a plurality of communication targets disposed in a projection range of the spatial optical signals.

As described above, the transmission device of the present example embodiment includes the light source, the spatial optical modulator, the reflection mirror, the condenser lens, the transparent diffuser, the ball lens, and the control unit (controller). The light source, the spatial optical modulator, the reflection mirror, the condenser lens, the transparent diffuser, and the ball lens constitute a transmitter. The condenser lens and the transparent diffuser constitute an optical diffuser. The light source includes an emitter that emits laser light. The light source emits light derived from the laser light emitted from the emitter. The spatial optical modulator includes the modulation part in which the phase image according to the spatial optical signal to be transmitted is set. The modulation part is irradiated with the light emitted from the light source. The reflection mirror has a curved reflection surface having a curvature according to a projection angle of the projection light transmitted as a spatial optical signal. The reflection mirror is disposed with the reflection surface facing the modulation part of the spatial optical modulator and the incident surface of the condenser lens. The condenser lens condenses the modulated light reflected by the reflection surface of the reflection minor. The transparent diffuser is disposed between the condenser lens and the ball lens. The transparent diffuser diffuses the modulated light condensed by the condenser lens. The ball lens enlarges and projects the modulated light diffused by the transparent diffuser. The modulated light enlarged and projected from the ball lens is projection light (spatial optical signal) of substantially parallel light. The control unit sets the phase image to be used for spatial optical communication in the modulation part of the spatial optical modulator included in the transmitter. The control unit controls the light source included in the transmitter in such a way that the light is emitted to the modulation part to which the phase image is set.

In the present example embodiment, the light emitted from the light source is emitted to the modulation part of the spatial optical modulator. The modulated light modulated by the modulation part is reflected by the reflection surface of the reflection minor and travels to the incident surface of the condenser lens. The beam diameter of the modulated light reflected by the reflection surface of the reflection mirror is enlarged according to the curvature of the reflection mirror. The modulated light is once condensed by the condenser lens, then diffused by the transparent diffuser, and incident in the ball lens in a state where the beam diameter is expanded. The modulated light incident in the ball lens is projected as projection light (spatial optical signal) of substantially parallel light. According to the present example embodiment, the beam diameter of the modulated light incident in the ball lens can be enlarged as compared with the first example embodiment. Therefore, according to the present example embodiment, the beam diameter of the spatial optical signal can be enlarged by enlarging the beam diameter on the incident surface of the condenser lens as compared with the configuration of the first example embodiment. In addition, according to the present example embodiment, a larger ball lens than that in the first example embodiment can be used. Therefore, according to the present example embodiment, the projection light having a larger beam diameter than the first example embodiment can be projected.

The transmission device according to an aspect of the present example embodiment includes the plurality of projection units each including the light source, the transparent diffuser, and the ball lens. The light emitted from the light source of each projection unit is emitted to a different modulation region set in the modulation part of the spatial optical modulator. The modulated light modulated in the modulation region associated with each projection unit is reflected by a different reflection region allocated to the reflection surface of the reflection mirror. The condenser lens of each projection unit condenses the modulated light derived from the light emitted from the light source of the projection unit, the light having been reflected by the reflection surface of the reflection mirror. The transparent diffuser of each projection unit diffuses the modulated light condensed by the condenser lens of the projection unit. The ball lens of each projection unit enlarges and projects the modulated light diffused by the transparent diffuser of the projection unit. The modulated light enlarged and projected from the ball lenses of the plurality of projection units is transmitted as spatial optical signals in different directions. In the present aspect, the plurality of spatial optical signals derived from the plurality of light sources is transmitted in different directions. Therefore, according to the present aspect, it is possible to communicate with a plurality of communication targets disposed in the projection range of the spatial optical signals.

### Third Example Embodiment

Next, a transmission device according to a third example embodiment will be described with reference to the drawings. The transmission device of the present example embodiment is different from the transmission device of the first example embodiment in that modulated light modulated by a spatial optical modulator is diffused by a reflective diffuser and guided to a ball lens. The configuration of the present example embodiment may be combined with the configuration of the second example embodiment.

(Configuration)

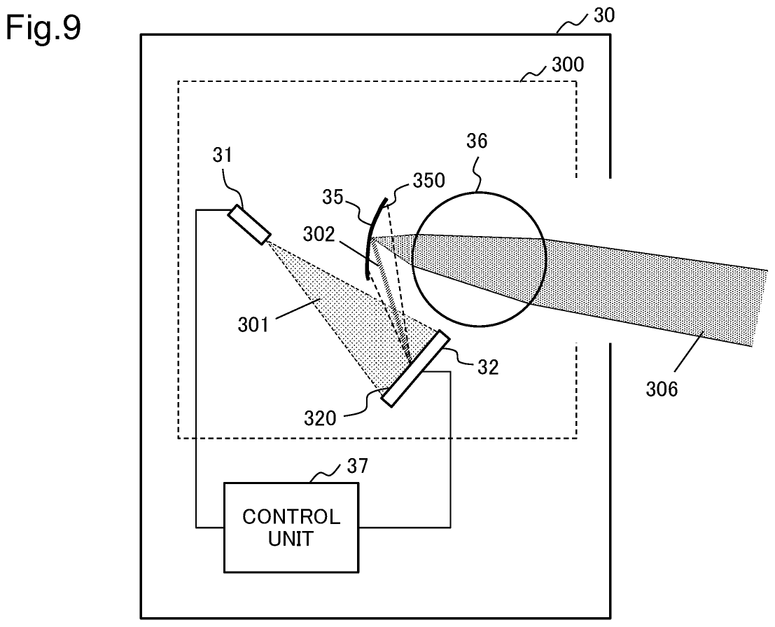

FIG. 9 is a conceptual diagram illustrating an example of a configuration of a transmission device 30 according to the present example embodiment. The transmission device 30 includes a light source 31, a spatial optical modulator 32, a diffuser 35, a ball lens 36, and a control unit 37. The light source 31, the spatial optical modulator 32, the diffuser 35, and the ball lens 36 constitute a transmitter 300. The diffuser 35 is a form of an optical diffuser. FIG. 9 is a side view of an internal configuration of the transmitter 300 as viewed from a side. FIG. 9 illustrates a cross section of the diffuser 35. FIG. 9 is conceptual and does not accurately represent a shape of each configuration element, a positional relationship between configuration elements, travel of light, and the like.

The light source 31 has a similar configuration to the light source 11 of the first example embodiment. The light source 31 emits light 301 under the control of the control unit 37. An optical axis of a light source 31 is obliquely set with respect to a surface of a modulation part 320 of a spatial optical modulator 32. The light source 31 emits laser light in a predetermined wavelength band under the control of the control unit 37.

The spatial optical modulator 32 has a similar configuration to the spatial optical modulator 12 of the first example embodiment. The spatial optical modulator 32 is disposed in an optical path of the light 301 emitted from the light source 31. The spatial optical modulator 32 includes a modulation part 320. A modulation region is set in the modulation part 320. In the modulation region of the modulation part 320, a pattern (also referred to as a phase image) according to an image displayed with projection light 306 is set under the control of control unit 37. The modulation part 320 is irradiated with the light 301 emitted from the light source 31. The light 301 incident on the modulation part 320 is modulated according to the pattern (phase image) set in the modulation part 320. The modulated light 302 modulated by the modulation part 320 travels toward a diffusion surface 350 of the diffuser 35.

The diffuser 35 is a reflective optical diffuser (also referred to as a reflective diffuser) having a spherical dome shape. On the diffusion surface 350 (concave surface) of the diffuser 35, randomly arrayed minute concave lenses are formed in an array. The modulated light 302 modulated by the modulation part 320 of the spatial optical modulator 32 is incident on the diffuser 35. The diffuser 35 diffuses the incident modulated light 302 by micro-lenses formed in an array. The modulated light 302 diffused by the diffuser 35 travels toward the ball lens 36. The modulated light 302 is diffused at a position where the micro-lens is formed. Therefore, a range of the modulated light 302 to be incident in the ball lens 36 can be shaped according to a range in which the micro-lens is formed.

The material of base material of the diffuser 35 is not limited as long as the diffusion layer that diffuses light is formed on the diffusion surface 350 (concave surface). For example, the micro-lens formed on the diffusion surface 350 can be formed using a transparent material such as polycarbonate, polyester, acrylic, or glass. A diffusion angle of the diffusion surface 350 can be adjusted by a state of the micro-lens. The smaller the size and the larger the density of the micro-lens, the larger the diffusion angle of the diffuser 35. The diffusion angle of the modulated light 302 reflected by the diffusion surface 350 may be adjusted according to a diameter of the ball lens 36, a distance between the diffuser 35 and the ball lens 36, or the like.

The ball lens 36 has a similar configuration to the ball lens 16 of the first example embodiment. The ball lens 36 is a spherical lens. The modulated light 302 diffused by the diffuser 35 is incident in the ball lens 36. The ball lens 36 converts the incident modulated light 302 into the projection light 306 of substantially parallel light and emits the projection light. The projection light 306 emitted from the ball lens 36 travels toward a communication target (not illustrated). When the projection light 306 is transmitted from the transmission device 30, the beam diameter is enlarged by the ball lens 36. Therefore, even in a case where raindrops or the like are interposed between the transmission device 30 and the communication target due to an influence of weather, the projection light 306 is less easily attenuated.

The control unit 37 (controller) has a similar configuration to the control unit 17 of the first example embodiment. The control unit 37 controls the light source 31 and the spatial optical modulator 32. The control unit 37 sets, in the modulation part 320 of the spatial optical modulator 32, the phase image associated to the image to be projected. The control unit 37 drives the light source 31 in a state where the phase image associated to the projection image is set in the modulation part 320. As a result, the light 301 emitted from the light source 31 is emitted to the modulation part 320 of the spatial optical modulator 32 in accordance with timing at which the phase image is set in the modulation part 320 of the spatial optical modulator 32. The light 301 emitted to the modulation part 320 of the spatial optical modulator 32 is modulated by the modulation part 320. The modulated light 302 modulated by the modulation part 320 is emitted toward the diffusion surface 350 of the diffuser 35. Further, the control unit 37 modulates the light 301 emitted from the light source 31 for communication with the communication target (not illustrated). In communication, the control unit 37 modulates the light 301 by controlling the timing at which the light 301 is emitted from the light source 31 in a state where the phase image for communication is set in the modulation part 320 of the spatial optical modulator 32.

(Modification)

Next, a modification of the present example embodiment will be described. Hereinafter, a modification in which a diffractive optical element is disposed instead of a diffuser will be described. The following modifications are merely examples, and do not limit modifications of the present example embodiment.

[Modification 3-1]

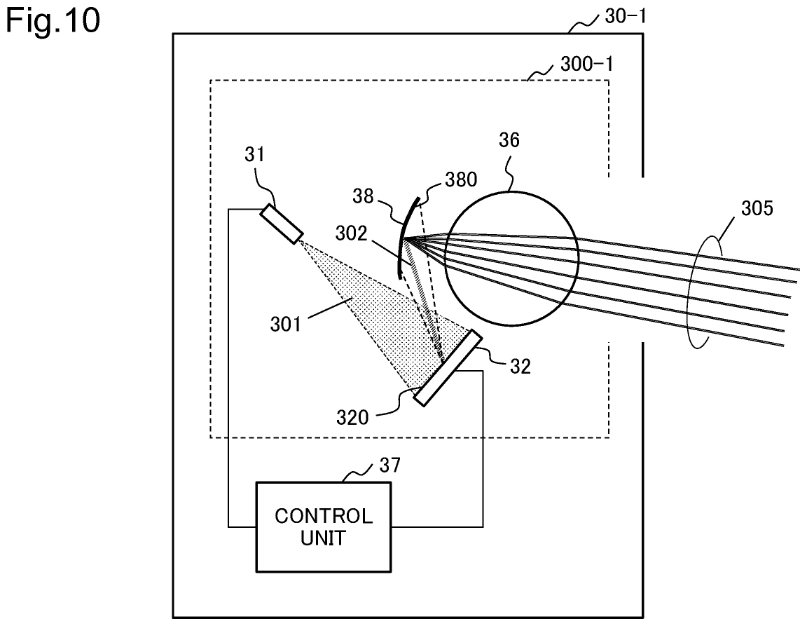

A modification 3-1 is an example in which a diffractive optical element 38 is disposed instead of the diffuser 35. FIG. 10 is a conceptual diagram illustrating an example of a configuration of a transmission device 30-1 according to the modification 3-1. The transmission device 30-1 includes the light source 31, the spatial optical modulator 32, the diffractive optical element 38, the ball lens 36, and the control unit 37. The light source 31, the spatial optical modulator 32, the diffractive optical element 38, the ball lens 36, and the control unit 37 constitute a transmitter 300-1. The diffractive optical element 38 is a form of an optical diffuser. FIG. 10 is a plan view of an internal configuration of the transmitter 300-1 as viewed from above. FIG. 10 illustrates a cross section of the diffractive optical element 38. FIG. 10 is conceptual and does not accurately represent a shape of each configuration element, a positional relationship between configuration elements, travel of light, and the like. The light source 31, the spatial optical modulator 32, the ball lens 36, and the control unit 37 have similar configurations to those in FIG. 9.

The diffractive optical element 38 is a reflective diffractive optical element (DOE) having a spherical dome shape. A diffractive reflection surface 380 (concave surface) of the diffractive optical element 38 is formed with submicron-order irregularities. The irregularities of the diffractive reflection surface 380 of the diffractive optical element 38 can be formed by three-dimensional nanoimprinting using a dedicated mold. A diffractive reflection surface 380 of the diffractive optical element 38 is set to face the ball lens 36.

The modulated light 302 modulated by the modulation part 320 of the spatial optical modulator 32 is incident on the diffractive reflection surface 380 of the diffractive optical element 38. The diffractive optical element 38 branches the incident modulated light 302 into a plurality of light fluxes. The modulated light 302 branched into the plurality of light fluxes is emitted from the diffractive reflection surface 380 of the diffractive optical element 38 toward the ball lens 36.

The light source 31 emits light 301 under the control of the control unit 37. The optical axis of the light source 31 is obliquely set with respect to the surface of the modulation part 320 of the spatial optical modulator 32. The light 301 emitted from the light source 31 is emitted to the modulation part 320 of the spatial optical modulator 32. A phase image is set in the modulation part 320 under the control of the control unit 37. The light 301 is modulated according to the phase image set in the modulation part 320. The modulated light 302 modulated by the modulation part 320 is incident on the diffractive reflection surface 380 of the diffractive optical element 38. The modulated light 302 incident on the diffractive reflection surface 380 is diffused by the diffractive reflection surface 380 and branched into a plurality of light fluxes. The plurality of light fluxes diffused by the diffractive reflection surface 380 is incident in the ball lens 36. The plurality of light fluxes incident in the ball lens 36 is converted into projection light 305 of substantially parallel light by the ball lens 36 and transmitted as spatial optical signals including the plurality of light fluxes.

In the present modification, the spatial optical signals including a plurality of light fluxes are transmitted in the same direction. Compared to a single light flux, each of the plurality of light fluxes has large energy. Further, a gap is formed between the plurality of light fluxes. Therefore, according to the present modification, it is possible to transmit highly robust spatial optical signals that are less easily attenuated by an influence of weather such as rain. For example, even if one of the plurality of light fluxes is temporarily blocked, communication with a communication target can be continued as long as the remaining light fluxes arrive at the communication target.

As described above, the transmission device of the present example embodiment includes the light source, the spatial optical modulator, the reflective transparent diffuser, the ball lens, and the control unit (controller). The light source, the spatial optical modulator, the reflective diffuser, and the ball lens constitute a transmitter. The condenser lens and the reflective diffuser constitute an optical diffuser. The light source includes an emitter that emits laser light. The light source emits light derived from the laser light emitted from the emitter. The spatial optical modulator includes the modulation part in which the phase image according to the spatial optical signal to be transmitted is set. The modulation part is irradiated with the light emitted from the light source. The reflective diffuser has a concave diffusion surface. The reflective diffuser is disposed with the diffusion surface facing the modulation part of the spatial optical modulator and the ball lens. The reflective diffuser diffuses the modulated light modulated by the modulation part toward the ball lens. The ball lens enlarges and projects the modulated light diffused by the reflective diffuser. The modulated light enlarged and projected from the ball lens is projection light (spatial optical signal) of substantially parallel light. The control unit sets the phase image to be used for spatial optical communication in the modulation part of the spatial optical modulator included in the transmitter. The control unit controls the light source included in the transmitter in such a way that the light is emitted to the modulation part to which the phase image is set.

In the present example embodiment, the light emitted from the light source is emitted to the modulation part of the spatial optical modulator. The modulated light modulated by the modulation part is diffused on the diffusion surface of the reflective diffuser and is incident in the ball lens. The modulated light incident in the ball lens is projected as projection light (spatial optical signal) of substantially parallel light. In the present example embodiment, the condenser lens can be omitted while the distance from the spatial optical modulator to the transparent diffuser is set to be long as compared with the first example embodiment. Therefore, according to the present example embodiment, the size of the transmission device can be reduced as compared with the configuration of the first example embodiment.

The transmission device according to an aspect of the present example embodiment includes a reflective diffractive optical element. The reflective diffractive optical element has a concave diffractive reflection surface that divides the modulated light modulated by the modulation part of the spatial optical modulator into a plurality of light fluxes. The reflective diffractive optical element is disposed with the diffractive reflection surface facing the modulation part of the spatial optical modulator and the ball lens. The reflective diffractive optical element divides the modulated light modulated by the modulation part of the spatial optical modulator into a plurality of light fluxes. According to the present aspect, the spatial optical signals including a plurality of light fluxes are transmitted in the same direction. Compared to a single light flux, each of the plurality of light fluxes has large energy. A gap is formed between the plurality of light fluxes. Further, according to the present example embodiment, the size of the transmission device can be reduced as compared with the configuration of the first example embodiment. Therefore, according to the present modification, it is possible to downsize the transmission device capable of transmitting highly robust spatial optical signals that are less easily attenuated by an influence of weather such as rain.

### Fourth Example Embodiment

Next, a transmission device according to a fourth example embodiment will be described with reference to the drawings. The transmission device of the present example embodiment is different from the transmission devices of the first to third example embodiments in that modulated light modulated by a spatial optical modulator is guided to a ball lens via a bundle of optical fibers (also referred to as a fiber bundle). The configuration of the present example embodiment may be combined with the configurations of the second and third example embodiments.

(Configuration)

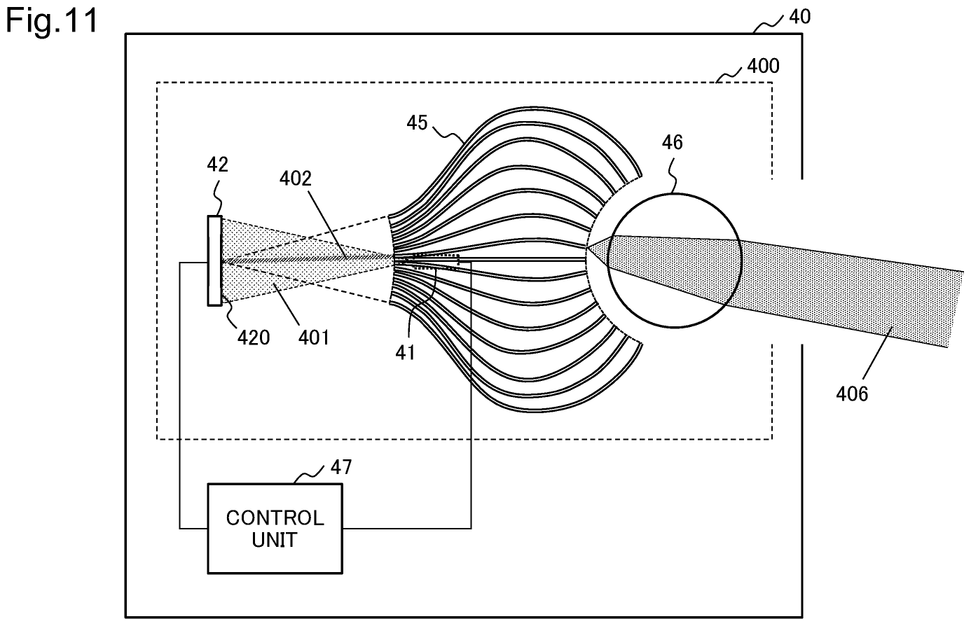

FIG. 11 is a conceptual diagram illustrating an example of a configuration of a transmission device 40 according to the present example embodiment. The transmission device 40 includes a light source 41, a spatial optical modulator 42, a fiber bundle 45, a ball lens 46, and a control unit 47. The light source 41, the spatial optical modulator 42, the fiber bundle 45, and the ball lens 46 constitute a transmitter 400. The fiber bundle is a form of an optical diffuser. FIG. 11 is a side view of an internal configuration of the transmitter 400 as viewed from above. FIG. 11 illustrates a cross section of the fiber bundle 45. Emission ends of a plurality of optical fibers constituting the fiber bundle 45 are disposed on a spherical surface toward a part (spherical dome) of the spherical surface of the ball lens 46. FIG. 11 is conceptual and does not accurately represent a shape of each configuration element, a positional relationship between configuration elements, travel of light, and the like.

The light source 41 has a similar configuration to the light source 11 of the first example embodiment. The light source 41 emits light 401 under the control of the control unit 47. An optical axis of a light source 41 is obliquely set with respect to a surface of a modulation part 420 of a spatial optical modulator 42. The light source 41 emits laser light in a predetermined wavelength band under the control of the control unit 47.

The spatial optical modulator 42 has a similar configuration to the spatial optical modulator 12 of the first example embodiment. The spatial optical modulator 42 is disposed in an optical path of the light 401 emitted from the light source 41. The spatial optical modulator 42 includes a modulation part 420. A modulation region is set in the modulation part 420. In the modulation region of the modulation part 420, a pattern (also referred to as a phase image) according to an image displayed with projection light 406 is set under the control of control unit 47. The modulation part 420 is irradiated with the light 401 emitted from the light source 41. The light 401 incident on the modulation part 420 is modulated according to the pattern (phase image) set in the modulation part 420. The modulated light 402 modulated by the modulation part 420 travels toward an incident end of any optical fiber among the plurality of optical fibers constituting the fiber bundle 45.

The fiber bundle 45 is a bundle of the plurality of optical fibers. One end (incident end) of the optical fiber constituting the fiber bundle 45 is directed to the modulation part 420 of the spatial optical modulator 42, and the other end (emission end) is directed to a central portion of the ball lens 46. The incident ends of the plurality of optical fibers are arrayed on a spherical surface centered at the central portion of the modulation part 420. The emission ends of the plurality of optical fibers are arrayed on the spherical surface centered on the central portion of the ball lens 46. Main bodies of the plurality of optical fibers are bent so as to draw a smooth curve from the incident ends toward the emission ends. The modulated light 402 (image) incident from the incident end is transmitted to the emission end through the main body. The modulated light 402 emitted from the emission end is diffused at the emission end and travels toward the ball lens 46.

For example, the fiber bundle 45 can be made of a material such as glass, crystal, or resin. In a case of receiving a spatial optical signal in a visible region, the fiber bundle 45 can be implemented by a material that transmits/refracts light in the visible region. For example, the fiber bundle 45 can be implemented by optical glass such as crown glass or flint glass. For example, the fiber bundle 45 can be implemented by crown glass such as Boron Kron (BK). For example, the fiber bundle 45 can be implemented by a flint glass such as Lanthanum Schwerflint (LaSF). For example, quartz glass can be applied to the fiber bundle 45. For example, a crystal such as sapphire can be applied to the fiber bundle 45. For example, a transparent resin such as acryl can be applied to the fiber bundle 45.

In a case where the spatial optical signal is light in a near-infrared region (hereinafter also referred to as near-infrared rays), a material that transmits the near-infrared rays is used for the fiber bundle 45. For example, in a case of receiving a spatial optical signal in a near-infrared region of about 1.5 micrometers (μm), a material such as silicon can be applied to the fiber bundle 45 in addition to glass, crystal, resin, or the like. In a case where the spatial optical signal is light in an infrared region (hereinafter also referred to as infrared rays), a material that transmits the infrared rays is used for the fiber bundle 45. For example, in a case where the spatial optical signal is infrared rays, a silicon, germanium, or chalcogenide-based material can be applied to the fiber bundle 45. The material of the fiber bundle 45 is not limited as long as the material can transmit/refract light in the wavelength region of the spatial optical signal. The material of the fiber bundle 45 may be appropriately selected according to a required refractive index and use.

The ball lens 46 has a similar configuration to the ball lens 16 of the first example embodiment. The ball lens 46 is a spherical lens. The modulated light 402 diffused by the fiber bundle 45 is incident in the ball lens 46. The ball lens 46 converts the incident modulated light 402 into the projection light 406 of substantially parallel light and emits the projection light. The projection light 406 emitted from the ball lens 46 travels toward a communication target (not illustrated). When the projection light 406 is transmitted from the transmission device 40, the beam diameter is enlarged by the ball lens 46. Therefore, even in a case where raindrops or the like are interposed between the transmission device 40 and the communication target due to an influence of weather, the projection light 406 is less easily attenuated.

The control unit 47 (controller) has a similar configuration to the control unit 17 of the first example embodiment. The control unit 47 controls the light source 41 and the spatial optical modulator 42. The control unit 47 sets, in the modulation part 420 of the spatial optical modulator 42, the phase image associated to the image to be projected. The control unit 47 drives the light source 41 in a state where the phase image associated to the projection image is set in the modulation part 420. As a result, the light 401 emitted from the light source 41 is emitted to the modulation part 420 of the spatial optical modulator 42 in accordance with timing at which the phase image is set in the modulation part 420 of the spatial optical modulator 42. The light 401 emitted to the modulation part 420 of the spatial optical modulator 42 is modulated by the modulation part 420. The modulated light 402 modulated by the modulation part 420 is emitted toward the incident end of any optical fiber constituting the fiber bundle 45. Further, the control unit 47 modulates the light 401 emitted from the light source 41 for communication with the communication target (not illustrated). In communication, the control unit 47 modulates the light 401 by controlling the timing at which the light 401 is emitted from the light source 41 in a state where the phase image for communication is set in the modulation part 420 of the spatial optical modulator 42.

As described above, the transmission device of the present example embodiment includes the light source, the spatial optical modulator, the fiber bundle, the ball lens, and the control unit (controller). The light source, the spatial optical modulator, the fiber bundle, and the ball lens constitute a transmitter. The light source includes an emitter that emits laser light. The light source emits light derived from the laser light emitted from the emitter. The spatial optical modulator includes the modulation part in which the phase image according to the spatial optical signal to be transmitted is set. The modulation part is irradiated with the light emitted from the light source. The fiber bundle has a structure in which the plurality of optical fibers are bundled. The incident ends of the plurality of optical fibers are disposed toward the modulation part of the spatial optical modulator. The emission ends of the plurality of optical fibers are disposed toward the ball lens. The ball lens enlarges and projects the modulated light diffused by the fiber bundle. The modulated light enlarged and projected from the ball lens is projection light (spatial optical signal) of substantially parallel light. The control unit sets the phase image to be used for spatial optical communication in the modulation part of the spatial optical modulator included in the transmitter. The control unit controls the light source included in the transmitter in such a way that the light is emitted to the modulation part to which the phase image is set.

In the present example embodiment, the light emitted from the light source is emitted to the modulation part of the spatial optical modulator. The modulated light modulated by the modulation part is guided by the optical fiber constituting the fiber bundle and emitted from the emission end toward the ball lens. The modulated light incident in the ball lens is projected as projection light (spatial optical signal) of substantially parallel light. In the present example embodiment, an irradiation area of the modulated light with respect to the ball lens can be enlarged as compared with the case of using the lens system as in the first example embodiment. Therefore, according to the present example embodiment, the beam diameter of the spatial optical signal can be enlarged as compared with the configuration of the first example embodiment.

In the transmission device of the present example embodiment, the emission end of the fiber bundle is disposed along the spherical surface of the ball lens. According to the present example embodiment, since the area of a portion (emission end) facing the ball lens is larger than that of the first to third example embodiments, a width of the projection light (spatial optical signal) can be increased. Therefore, according to the present example embodiment, it is possible to transmit the spatial optical signal that is less likely to be affected by the influence of disturbance such as rain as compared with the first to third example embodiments.

### Fifth Example Embodiment

Next, a communication device according to a fifth example embodiment will be described with reference to the drawings. The communication device of the present example embodiment has a configuration in which a reception device and a transmission device are combined. The transmission device has the configurations of the first to fourth example embodiments. The reception device receives a spatial optical signal. Hereinafter, an example of the reception device having a light receiving function including a ball lens will be described. Note that the communication device of the present example embodiment may include a reception device having the light receiving function that does not include a ball lens.

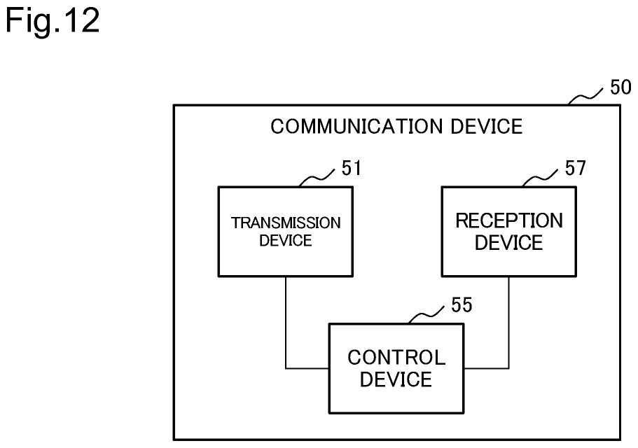

FIG. 12 is a conceptual diagram illustrating an example of a configuration of a communication device 50 according to the present example embodiment. The communication device 50 includes a transmission device 51, a control device 55, and a reception device 57. The communication device 50 transmits and receives spatial optical signals to and from an external communication target. Therefore, an opening or a window for transmitting and receiving the spatial optical signal is formed in the communication device 50.

The transmission device 51 is the transmission device of the first example embodiment. The transmission device 51 acquires a control signal from the control device 55. The transmission device 51 projects the spatial optical signal according to the control signal. The spatial optical signal projected from the transmission device 51 is received by the communication target (not illustrated) at a transmission destination of the spatial optical signal.

The control device 55 acquires a signal output from the reception device 57. The control device 55 executes processing according to the acquired signal. The processing executed by the control device 55 is not particularly limited. The control device 55 outputs a control signal for transmitting an optical signal according to the executed processing to the transmission device 51. For example, the control device 55 executes processing based on a predetermined condition according to information included in the signal received by the reception device 57. For example, the control device 55 executes processing designated by an administrator of the communication device 50 according to the information included in the signal received by the reception device 57.

The reception device 57 receives the spatial optical signal transmitted from the communication target (not illustrated). The reception device 57 converts the received spatial optical signal into an electrical signal. The reception device 57 outputs the converted electrical signal to the control device 55. For example, the reception device 57 has a light receiving function including a ball lens. Furthermore, the reception device 57 may have a light receiving function that does not include a ball lens.

[Reception Device]

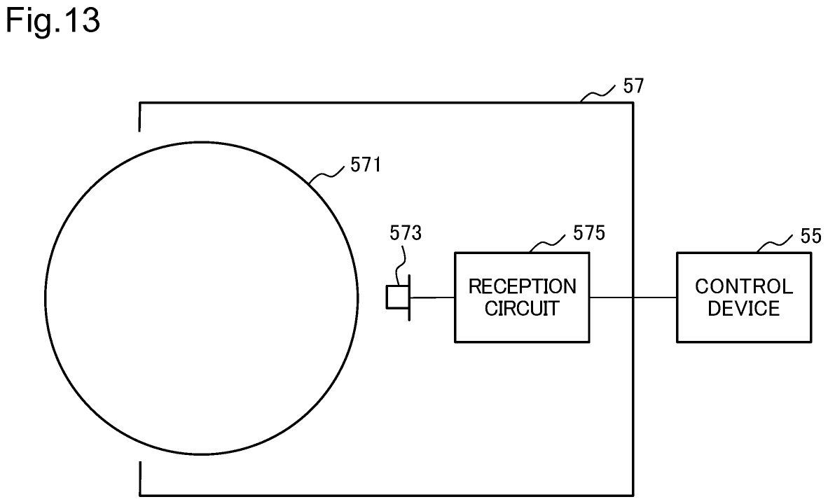

Next, a configuration of the reception device 57 will be described with reference to the drawings. FIG. 13 is a conceptual diagram for describing an example of a configuration of the reception device 57. The reception device 57 includes a ball lens 571, a light receiving element 573, and a reception circuit 575. FIG. 13 is a side view of an internal configuration of the reception device 57 as viewed from a lateral direction. The position of the reception circuit 575 is not particularly limited. The reception circuit 575 may be disposed inside the reception device 57 or may be disposed outside the reception device 57. Further, the function of the reception circuit 575 may be included in the control device 55.

The ball lens 571 is a spherical lens. The ball lens 571 is an optical element that condenses the spatial optical signal transmitted from the communication target. The ball lens 571 has a spherical shape when viewed from an optional angle. A part of the ball lens 571 protrudes through an opening opened in a housing of the reception device 57. The ball lens 571 condenses the incident spatial optical signal. The spatial optical signal incident in the ball lens 571 protruding through the opening is condensed. A part of the ball lens 571 may not protrude through the opening as long as the spatial optical signal can be condensed.

Light (also referred to as an optical signal) derived from the spatial optical signal condensed by the ball lens 571 is condensed toward a condensing region of the ball lens 571. Since the ball lens 571 has a spherical shape, the ball lens condenses the spatial optical signal arriving from an optional direction. That is, the ball lens 571 exhibits similar light condensing performance for the spatial optical signal arriving from an optional direction. The light incident in the ball lens 571 is refracted when entering the inside of the ball lens 571. Further, the light traveling inside the ball lens 571 is refracted again when being emitted to the outside of the ball lens 571. Most of the light emitted from the ball lens 571 is condensed in the condensing region.

For example, the ball lens 571 can be configured by a material such as glass, crystal, or resin. In a case of receiving the spatial optical signal in a visible region, the ball lens 571 can be implemented by a material that transmits/refracts light in the visible region. For example, the ball lens 571 can be implemented by optical glass such as crown glass or flint glass. For example, the ball lens 571 can be implemented by crown glass such as Boron Kron (BK). For example, the ball lens 571 can be implemented by a flint glass such as Lanthanum Schwerflint (LaSF). For example, quartz glass can be applied to the ball lens 571. For example, a crystal such as sapphire can be applied to the ball lens 571. For example, a transparent resin such as acrylic can be applied to the ball lens 571.

In a case where the spatial optical signal is light in a near-infrared region (hereinafter also referred to as near-infrared rays), a material that transmits the near-infrared rays is used for the ball lens 571. For example, in a case of receiving a spatial optical signal in a near-infrared region of about 1.5 micrometers (μm), a material such as silicon can be applied to the ball lens 571 in addition to glass, crystal, resin, or the like. In a case where the spatial optical signal is light in an infrared region (hereinafter also referred to as infrared rays), a material that transmits the infrared rays is used for the ball lens 571. For example, in the case where the spatial optical signal is infrared rays, the silicon, germanium, or chalcogenide-based material can be applied to the ball lens 571. The material of the ball lens 571 is not limited as long as the material can transmit/refract light in the wavelength region of the spatial optical signal. The material of the ball lens 571 may be appropriately selected according to the required refractive index and use.

The ball lens 571 may be replaced with another concentrator as long as the spatial optical signal can be condensed toward the region where the light receiving element 573 is disposed. For example, the ball lens 571 may be a light beam control element that guides the incident spatial optical signal toward the light receiving unit of the light receiving element 573. For example, the ball lens 571 may have a configuration in which a lens and a light beam control element are combined. For example, a mechanism that guides the optical signal condensed by the ball lens 571 toward the light receiving unit of the light receiving element 573 may be added.

The light receiving element 573 is disposed at a subsequent stage of the ball lens 571. The light receiving element 573 is disposed in the condensing region of the ball lens 571. The light receiving element 573 includes the light receiving unit that receives the optical signal condensed by the ball lens 571. The optical signal condensed by the ball lens 571 is received by the light receiving unit of the light receiving element 573. The light receiving element 573 converts the received optical signal into an electrical signal (hereinafter also referred to as a signal). The light receiving element 573 outputs the converted signal to the reception circuit 575. FIG. 13 illustrates an example of a single light receiving element 573. For example, a plurality of light receiving elements 573 may be disposed in the condensing region of the ball lens 571. For example, a light receiving element array in which a plurality of light receiving elements 573 is arrayed may be disposed in the condensing region of the ball lens 571.

The light receiving element 573 receives light in a wavelength region of the spatial optical signal to be received. For example, the light receiving element 573 has sensitivity to light in the visible region. For example, the light receiving element 573 has sensitivity to light in an infrared region. The light receiving element 573 has sensitivity to light having a wavelength in a 1.5 μm (micrometer) band, for example. Note that the wavelength band of light with which the light receiving element 573 has sensitivity is not limited to the 1.5 μm band. The wavelength band of the light received by the light receiving element 573 can be optionally set in accordance with the wavelength of the spatial optical signal to be received. The wavelength band of the light received by the light receiving element 573 may be set to, for example, a 0.8 μm band, a 1.55 μm band, or a 2.2 μm band. Further, the wavelength band of the light received by the light receiving element 573 may be, for example, a 0.8 to 1 μm band. A shorter wavelength band is advantageous for optical spatial communication during rainfall because absorption by moisture in the atmosphere is small. In addition, if saturation occurs due to intense sunlight, the light receiving element 573 cannot read the optical signal derived from the spatial optical signal. Therefore, a color filter that selectively passes the light of the wavelength band of the spatial optical signal may be installed at a preceding stage of the light receiving element 573.

For example, the light receiving element 573 can be implemented by an element such as a photodiode or a phototransistor. For example, the light receiving element 573 is implemented by an avalanche photodiode. The light receiving element 573 implemented by the avalanche photodiode can support high-speed communication. Note that the light receiving element 573 may be implemented by an element other than a photodiode, a phototransistor, or an avalanche photodiode as long as the element can convert the optical signal into an electrical signal. To improve communication speed, the light receiving unit of the light receiving element 573 is favorably as small as possible. For example, the light receiving unit of the light receiving element 573 has a square light receiving surface with a side of about 5 millimeters (mm). For example, the light receiving unit of the light receiving element 573 has a circular light receiving surface with a diameter of about 0.1 to 0.3 mm. The size and shape of the light receiving unit of the light receiving element 573 may be selected according to the wavelength band, the communication speed, or the like of the spatial optical signal.

For example, a polarization filter (not illustrated) may be disposed in front of the light receiving element 573. The polarization filter is disposed in association with the light receiving unit of the light receiving element 573. For example, the polarization filter is disposed to overlap the light receiving unit of the light receiving element 573. For example, the polarization filter may be selected according to a polarization state of the spatial optical signal to be received. For example, in a case where the spatial optical signal to be received is linearly polarized light, the polarization filter includes a ½ wave plate. For example, in a case where the spatial optical signal to be received is circularly polarized light, the polarization filter includes a ¼ wave plate. The polarization state of the optical signal having passed through the polarization filter is converted according to polarization characteristics of the polarization filter.

The reception circuit 575 acquires a signal output from the light receiving element 573. The reception circuit 575 amplifies the signal from the light receiving element 573. The reception circuit 575 decodes the amplified signal. The signal decoded by the reception circuit 575 is used for any purpose. The use of the signal decoded by the reception circuit 575 is not particularly limited.

[Communication Device]

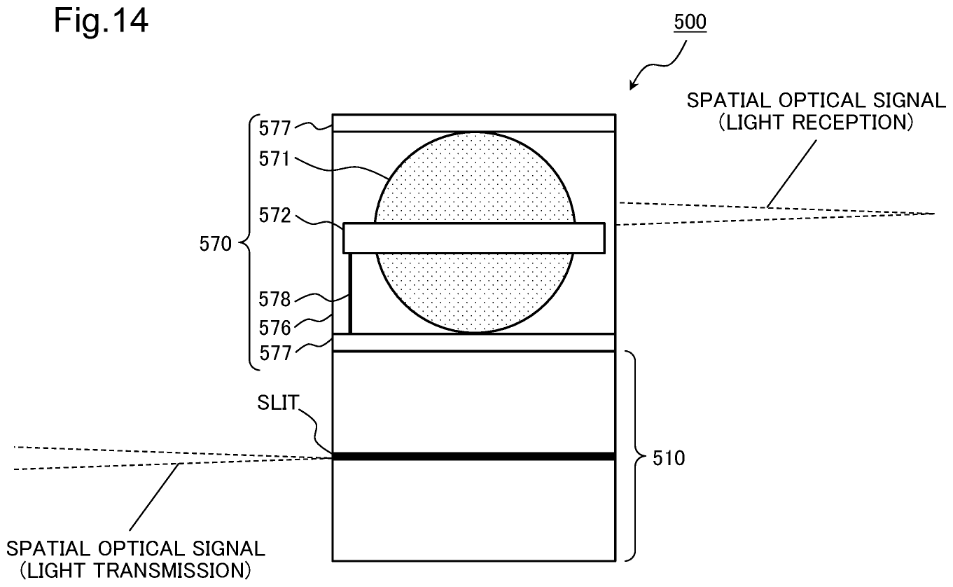

FIG. 14 is a conceptual diagram illustrating an example (communication device 500) of the communication device 50. The communication device 500 includes a transmitter 510, a receiver 570, and a control device (not illustrated). In FIG. 14, the reception circuit and the control device are omitted. The communication device 500 has a configuration in which the transmitter 510 and the receiver 570 having a cylindrical outer shape are combined.

The receiver 570 includes the ball lens 571, a light receiver 572, a color filter 576, a support member 577, and a conductive wire 578. Upper and lower portions of the ball lens 571 are sandwiched between a pair of the support members 577 that are disposed in an up-down direction Since the upper and lower portions of the ball lens 571 are not used for transmission and reception of the spatial optical signals, they may be processed into a planar shape so as to be easily sandwiched by the support members 577. The light receiver 572 is disposed in accordance with the condensing region of the ball lens 571 so as to be able to receive the spatial optical signal to be received. The light receiver 572 includes a light receiving element array in which a plurality of light receiving elements is annularly arrayed. The plurality of light receiving elements is arrayed in the condensing region of the ball lens 571. The plurality of light receiving elements is disposed with the light receiving unit facing the ball lens 571. The plurality of light receiving elements is connected to the control device (not illustrated) and the transmitter 510 by the conductive wire 578.

The color filter 576 is disposed on a side surface of the cylindrical receiver 570. The color filter 576 removes unnecessary light and selectively transmits the spatial optical signal used for communication. The pair of support members 577 is disposed on upper and lower surfaces of the cylindrical receiver 570. The pair of support members 577 sandwich the ball lens 571 from above and below. The annularly formed light receiver 572 is disposed on the emission side of the ball lens 571. The spatial optical signal incident in the ball lens 571 through the color filter 576 is condensed toward the light receiver 572 by the ball lens 571. The optical signal condensed by the light receiver 572 is guided toward the light receiving unit of one of the light receiving elements. The optical signal that has reached the light receiving unit of the light receiving element is received by the light receiving element. The control device (not illustrated) causes the transmitter 510 to transmit the spatial optical signal according to the optical signal received by the light receiving element included in the light receiver 572.

The transmitter 510 includes the transmission device according to any one of the first to fourth example embodiments. The transmitter 510 is housed inside a cylindrical housing. A slit opened in accordance with a transmission direction of the spatial optical signal by the transmitter 510 is formed in the cylindrical housing. For example, in a case where the transmitter 510 can transmit the spatial optical signals in the directions of 360 degrees, the slit is formed in the side surface of the housing of the transmitter 510 in accordance with the transmission direction of the spatial optical signal.

### Application Example

Next, an application example of the present example embodiment will be described with reference to the drawings. In the following application example, an example in which a plurality of communication devices transmit and receive the spatial optical signals will be described. Each of the communication devices has the configuration of the communication device 500 according to the fifth example embodiment.

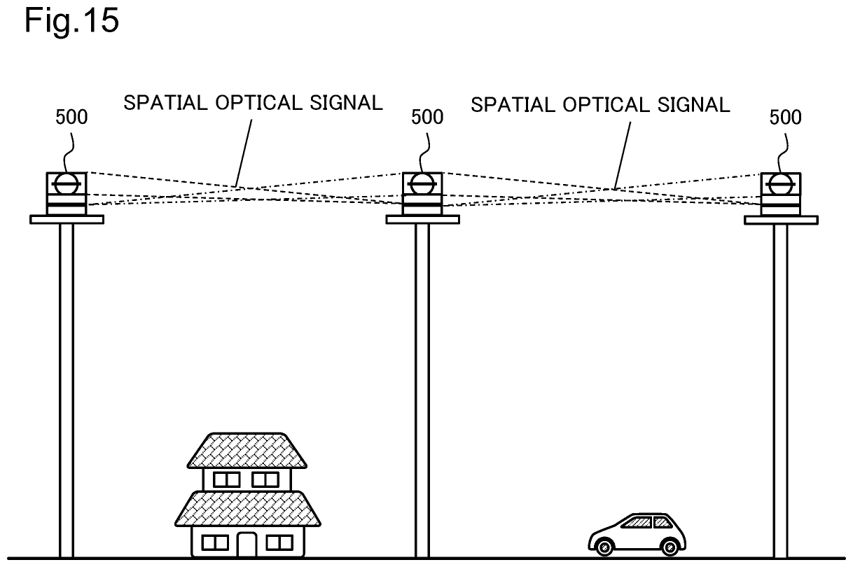

FIG. 15 is a conceptual diagram for describing the present application example. In the present application example, an example of a communication network (also referred to as a communication system) in which a plurality of the communication devices 500 is disposed on upper portions of poles such as utility poles or street lamps (also referred to as on-pole space) disposed in a town will be described.

There are few obstacles in the on-pole space. Therefore, the on-pole space is suitable for installing the communication devices 500. In addition, an arrival direction of the spatial optical signals is limited to a horizontal direction by installing the communication devices 500 at the same level of height. Therefore, the device can be simplified by reducing the light receiving area of the light receiver 572 constituting the receiver 570. The pair of communication devices 500 that transmits and receives the spatial optical signal is disposed in such a way that at least one communication device 500 receives the spatial optical signal transmitted from the other communication device 500. The pair of communication devices 500 may be disposed to transmit and receive the spatial optical signals to and from each other. In the case where the communication network of the spatial optical signal is configured by the plurality of communication devices 500, the communication device 500 positioned in the middle may be disposed to relay the spatial optical signal transmitted from another communication device 500 to another communication device 500.

According to the present application example, communication using the spatial optical signal can be performed among the plurality of communication devices 500 disposed in the on-pole space. For example, communication by wireless communication may be performed between a wireless device or a base station installed in an automobile, a house, or the like and the communication device 500 according to the communication between the communication devices 500. For example, the communication device 500 may be connected to the Internet via a communication cable or the like installed on a pole

As described above, the communication device according to the present example embodiment includes the reception device, the transmission device, and the control device. The transmission device includes the light source, the spatial optical modulator, the optical diffuser, the ball lens, and the control unit (controller). The light source, the spatial optical modulator, the optical diffuser, and the ball lens constitute a transmitter. The light source includes an emitter that emits laser light. The light source emits light derived from the laser light emitted from the emitter. The spatial optical modulator includes the modulation part in which the phase image according to the spatial optical signal to be transmitted is set. The modulation part is irradiated with the light emitted from the light source. The optical diffuser diffuses the modulated light modulated by the modulation part of the spatial optical modulator. The ball lens enlarges and projects the modulated light diffused by the optical diffuser. The modulated light enlarged and projected from the ball lens is projection light (spatial optical signal) of substantially parallel light. The control unit sets the phase image to be used for spatial optical communication in the modulation part of the spatial optical modulator included in the transmitter. The control unit controls the light source included in the transmitter in such a way that the light is emitted to the modulation part to which the phase image is set. The reception device receives the spatial optical signal. The control device acquires a signal based on the spatial optical signal from another communication device and received by the reception device. The control device executes processing according to the acquired signal. The control device causes the transmission device to transmit the spatial optical signal according to the executed processing.

In the transmission device included in the communication device of the present example embodiment, the light emitted from the light source is emitted to the modulation part of the spatial optical modulator. The modulated light modulated by the modulation part is incident in the ball lens in the state where the modulated light is diffused by the diffuser and the beam diameter is expanded. The modulated light incident in the ball lens is projected as projection light (spatial optical signal) of substantially parallel light. Therefore, the spatial optical signal transmitted from the communication device of the present example embodiment has a larger beam diameter immediately after transmission and is less likely to be affected by disturbance such as rain than a case where the spatial optical signal is transmitted without expanding the beam diameter. Further, since the spatial optical signal transmitted from the communication device of the present example embodiment is substantially parallel light, it is difficult to spread even when the light is away from the transmission device and the directivity is high. That is, according to the communication device of the present example embodiment, it is possible to transmit the directional spatial optical signal that is less likely to be affected by disturbance such as rain.

The communication system according to an aspect of the present example embodiment includes a plurality of the above-described communication devices. In the communication system, the plurality of communication devices are disposed to transmit and receive the spatial optical signals to and from each other. According to the present aspect, it is possible to implement the communication network that transmits and receives the spatial optical signals.

### Sixth Example Embodiment

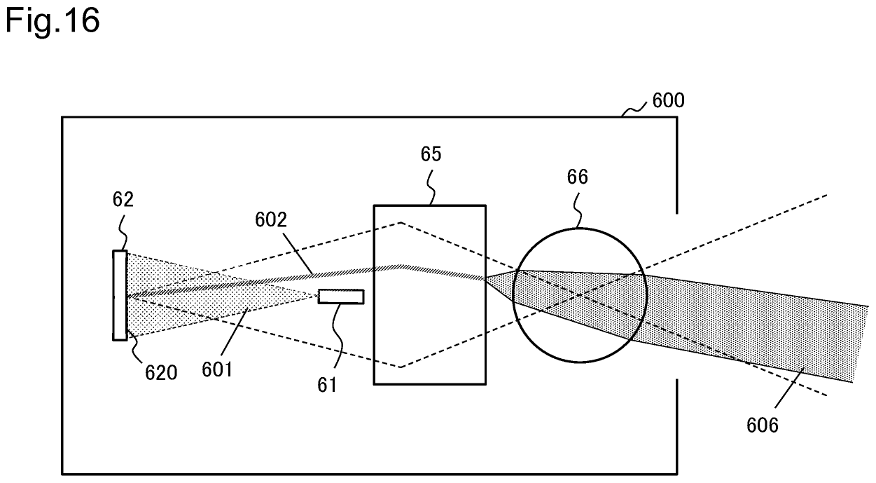

Next, a transmitter according to a sixth example embodiment will be described with reference to the drawings. The transmitter in the present example embodiment has a configuration in which the transmitter in the first example embodiment is simplified. FIG. 16 is a conceptual diagram illustrating an example of a configuration of a transmitter 600 according to the present example embodiment. FIG. 16 is a plan view of an internal configuration of the transmitter 600 as viewed from above. The transmitter 600 includes a light source 61, a spatial optical modulator 62, an optical diffuser 65, and a ball lens 66.

The light source 61 includes an emitter that emits laser light. The light source 61 emits light 601 derived from the laser light emitted from the emitter. The spatial optical modulator 62 includes a modulation part 620 in which a phase image according to a spatial optical signal to be transmitted is set. The modulation part 620 is irradiated with the light 601 emitted from the light source 61. The optical diffuser 65 diffuses the modulated light 602 modulated by the modulation part 620 of the spatial optical modulator 62. The ball lens 66 enlarges and projects the modulated light 602 diffused by the optical diffuser 65. The modulated light 602 enlarged and projected from the ball lens 66 is projection light 606 (spatial optical signal) of substantially parallel light.

As described above, in the present example embodiment, the light emitted from the light source is emitted to the modulation part of the spatial optical modulator. The modulated light modulated by the modulation part is incident in the ball lens in a state where the modulated light is diffused by the diffuser and a beam diameter is expanded. The modulated light incident in the ball lens is projected as projection light (spatial optical signal) of substantially parallel light. Therefore, the spatial optical signal transmitted from the transmitter of the present example embodiment has a larger beam diameter immediately after transmission and is less likely to be affected by disturbance such as rain than a case where the spatial optical signal is transmitted without expanding the beam diameter. Further, since the spatial optical signal transmitted from the transmitter of the present example embodiment is substantially parallel light, it is difficult to spread even when the light is away from the transmission device and the directivity is high. That is, according to the transmitter of the present example embodiment, it is possible to transmit the directional spatial optical signal that is less likely to be affected by disturbance such as rain.

(Hardware)

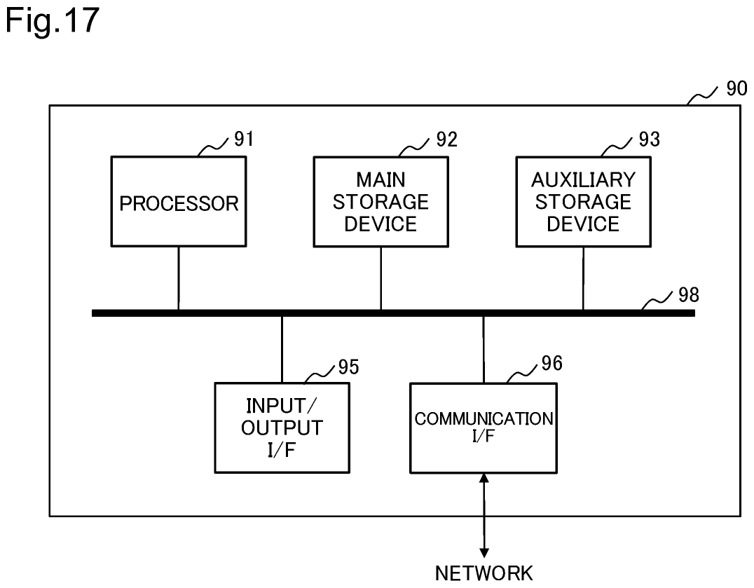

Here, a hardware configuration for executing the control and processing according to each example embodiment of the present disclosure will be described using an information processing device 90 (computer) of FIG. 17 as an example. Note that the information processing device 90 in FIG. 17 is a configuration example for executing the control and processing of each example embodiment, and does not limit the scope of the present disclosure.

As illustrated in FIG. 17, the information processing device 90 includes a processor 91, a main storage device 92, an auxiliary storage device 93, an input/output interface 95, and a communication interface 96. In FIG. 17, an interface is abbreviated as an I/F. The processor 91, the main storage device 92, the auxiliary storage device 93, the input/output interface 95, and the communication interface 96 are data-communicably connected to one another via a bus 98. In addition, the processor 91, the main storage device 92, the auxiliary storage device 93, and the input/output interface 95 are connected to a network such as the Internet or an intranet via the communication interface 96.

The processor 91 expands a program (instruction) stored in the auxiliary storage device 93 or the like in the main storage device 92. For example, the program is a software program for executing the control and processing of each example embodiment. The processor 91 executes the program expanded in the main storage device 92. The processor 91 executes the program to execute the control and processing according to each example embodiment.

The main storage device 92 has an area in which the program is expanded. The program stored in the auxiliary storage device 93 or the like is expanded in the main storage device 92 by the processor 91. The main storage device 92 is implemented by, for example, a volatile memory such as a dynamic random access memory (DRAM). In addition, a nonvolatile memory such as a magneto resistive random access memory (MRAM) may be configured/added as the main storage device 92.

The auxiliary storage device 93 stores various data such as programs. The auxiliary storage device 93 is implemented by a local disk such as a hard disk or a flash memory. Note that various data may be stored in the main storage device 92, and the auxiliary storage device 93 may be omitted.

The input/output interface 95 is an interface for connecting the information processing device 90 and a peripheral device on the basis of a standard or a specification. The communication interface 96 is an interface for being connected to an external system or device through a network such as the Internet or an intranet on the basis of a standard or a specification. The input/output interface 95 and the communication interface 96 may be shared as an interface connected to an external device.

Input devices such as a keyboard, a mouse, and a touch panel may be connected to the information processing device 90 as necessary. These input devices are used to input information and settings. In the case where a touch panel is used as the input device, a screen having a touch panel function serves as the interface. The processor 91 and the input device are connected via the input/output interface 95.

The information processing device 90 may be provided with a display device for displaying information. In the case where the display device is provided, the information processing device 90 favorably includes a display control device (not illustrated) for controlling display of the display device. The information processing device 90 and the display device are connected via the input/output interface 95.

The information processing device 90 may be provided with a drive device. The drive device mediates reading of data and a program stored in a recording medium and writing of a processing result of the information processing device 90 to the recording medium between the processor 91 and the recording medium (program recording medium). The information processing device 90 and the drive device are connected via the input/output interface 95.

The above is an example of a hardware configuration for enabling the control and processing according to each example embodiment of the present invention. The hardware configuration of FIG. 17 is an example of a hardware configuration for executing the control and processing according to each example embodiment, and does not limit the scope of the present invention. A program for causing a computer to execute the control and processing according to each example embodiment is also included in the scope of the present invention.

A program recording medium in which the program according to each example embodiment is recorded is also included in the scope of the present invention. The recording medium can be implemented by, for example, an optical recording medium such as a compact disc (CD) or a digital versatile disc (DVD). The recording medium may be implemented by a semiconductor recording medium such as a universal serial bus (USB) memory or a secure digital (SD) card. Further, the recording medium may be implemented by a magnetic recording medium such as a flexible disk, or another recording medium. In the case where the program executed by the processor is recorded in the recording medium, the recording medium corresponds to a program recording medium.

The configuration elements of the example embodiments may be optionally combined. The configuration elements of the example embodiments may be implemented by software. The configuration elements of each example embodiment may be implemented by a circuit.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A transmitter comprising:
a light source;
a spatial optical modulator including a modulation part in which a phase image according to a spatial optical signal to be transmitted is set and irradiated with light emitted from the light source;
an optical diffuser that diffuses modulated light modulated by the modulation part of the spatial optical modulator; and
a ball lens that enlarges and projects the modulated light diffused by the optical diffuser.

2. The transmitter according to claim 1, wherein
the optical diffuser includes
a condenser lens that condenses the modulated light modulated by the modulation part of the spatial optical modulator, and
a transparent diffuser that is disposed between the condenser lens and the ball lens and diffuses the modulated light condensed by the condenser lens.

3. The transmitter according to claim 1, wherein
the optical diffuser includes
a condenser lens that condenses the modulated light modulated by the modulation part of the spatial optical modulator, and
a transmissive diffractive optical element that is disposed between the condenser lens and the ball lens and divides the modulated light condensed by the condenser lens into a plurality of light fluxes.

4. The transmitter according to claim 2, further comprising:
a reflection mirror having a curved reflection surface having a curvature according to a projection angle of projection light transmitted as the spatial optical signal, wherein
the reflection mirror
is disposed with the reflection surface facing the modulation part of the spatial optical modulator and an incident surface of the condenser lens.

5. The transmitter according to claim 1, further comprising: a reflective diffuser having a concave diffusion surface and disposed with the diffusion surface facing the modulation part of the spatial optical modulator and the ball lens.

6. The transmitter according to claim 1, further comprising: a reflective diffractive optical element having a concave diffractive reflection surface that divides the modulated light modulated by the modulation part of the spatial optical modulator into a plurality of light fluxes, and disposed with the diffractive reflection surface facing the modulation part of the spatial optical modulator and the ball lens.

7. The transmitter according to claim 1, wherein
the optical diffuser is
a fiber bundle in which a plurality of optical fibers are bundled,
incident ends of the plurality of optical fibers are disposed toward the modulation part of the spatial optical modulator, and
emission ends of the plurality of optical fibers are disposed toward the ball lens.

8. A transmission device comprising:
the transmitter according to claim 1; and
a controller configured to set a phase image to be used for spatial optical communication in the modulation part of the spatial optical modulator included in the transmitter, and control the light source included in the transmitter in such a way that the modulation part in which the phase image is set is irradiated with light.

9. A communication device comprising:
the transmission device according to claim 8;
a reception device that receives a spatial optical signal; and
a control device that acquires a signal based on the spatial optical signal from another communication device, the spatial optical signal having been received by the reception device, executes processing according to the acquired signal, and causes the transmission device to transmit a spatial optical signal according to the executed processing.

10. A communication system comprising:
a plurality of the communication devices according to claim 9, wherein
the plurality of communication devices are disposed to mutually transmit and receive a spatial optical signal.
